(19) United States
(12) Patent Application Publication
(10) Pub. No.: US 2026/0003614 A1
(43) Pub. Date: Jan. 1, 2026

(54) APPARATUS, METHOD, AND COMPUTER PROGRAM PRODUCT FOR OUTPUTTING A DEVELOPMENT RESOURCE REFERENCE UNIT IMPACT INTERFACE COMPONENT TO A DEVELOPMENT RESOURCE REFERENCE UNIT INTERFACE AND OUTPUTTING A TECHNOLOGY OPERATIONS INCIDENT EVENT RESPONSE INTERFACE COMPONENT TO A TECHNOLOGY OPERATIONS INCIDENT EVENT RESPONSE INTERFACE

(71) Applicant: ATLASSIAN PTY LTD., Sydney (AU)

(72) Inventors: Atri Mandal, Bangalore (IN); Bhavya Narang, New Delhi (IN); Mrigank Mrigank, Kolkata (IN); Yashasvi Galav, Antah (IN)

(21) Appl. No.: 19/251,116

(22) Filed: Jun. 26, 2025

Related U.S. Application Data
(63) Continuation of application No. 18/756,156, filed on Jun. 27, 2024.

(51) Int. Cl. G06F 8/77; G06N 20/00

(52) U.S. Cl. CPC G06F 8/77; G06N 20/00

(57) ABSTRACT

Apparatus, methods, and computer program products for outputting a technology operations incident event response interface component for rendering to a technology operations incident event response interface. A method may include identifying a technology operations incident event, filtering a plurality of development resource reference unit embedding vectors, generating a candidate development resource reference unit structure, generating a candidate technology operations incident responsive direction, generating a technology operations incident event response interface component, and outputting the technology operations incident event response interface component.

### CROSS REFERENCE TO RELATED APPLICATIONS

This application is a continuation of and claims priority to U.S. patent application Ser. No. 18/756,156, filed Jun. 27, 2024, the entire contents of which are incorporated by reference herein.

### BACKGROUND

Various methods, apparatuses, and systems provide tools to plan, collaborate, execute, address, resolve and monitor units, events, vectors, and interface components in resource development and technology operations environments. Applicant has identified a number of deficiencies and problems associated with tools for effectively, reliably, and securely managing units, events, vectors, and interface components in resource development and technology operations systems. Through applied effort, ingenuity, and innovation, many of these identified deficiencies and problems have been solved by developing solutions that are structured in accordance with the embodiments of the present disclosure, many examples of which are described in detail herein.

### BRIEF SUMMARY

In general, embodiments of the present disclosure provided herein include improved methods, apparatuses, computer program products, and/or the like that are configured for effectively and efficiently outputting, in a resource development and technology operations system, a technology operations incident event response interface component and/or a development resource reference unit impact interface component.

In accordance with some exemplary embodiments of the present disclosure, an example apparatus for outputting a resource development generation interface component to a resource operational interface is provided. In some embodiments, the apparatus may comprise at least one processor and at least one memory including program code. In some embodiments, the at least one memory and the program code are configured to, with the at least one processor, cause the apparatus to identify a technology operations incident event. In some embodiments, the at least one memory and the program code are configured to, with the at least one processor, cause the apparatus to filter a plurality of development resource reference unit embedding vectors based at least in part on a technology operations incident nature classification associated with the technology operations incident event to identify a candidate development resource reference unit embedding vector. In some embodiments, the at least one memory and the program code are configured to, with the at least one processor, cause the apparatus to generate a candidate development resource reference unit structure based at least in part on the candidate development resource reference unit embedding vector. In some embodiments, the candidate development resource reference unit structure includes a candidate development resource reference unit fragment and a candidate development resource reference unit link. In some embodiments, the at least one memory and the program code are configured to, with the at least one processor, cause the apparatus to generate a candidate technology operations incident responsive direction by processing the candidate development resource reference unit fragment using a technology operations incident responsive direction generation model. In some embodiments, the at least one memory and the program code are configured to, with the at least one processor, cause the apparatus to generate a technology operations incident event response interface component comprising the candidate development resource reference unit structure and the candidate technology operations incident responsive direction. In some embodiments, the at least one memory and the program code are configured to, with the at least one processor, cause the apparatus to output the technology operations incident event response interface component for rendering to a technology operations incident event response interface.

In some embodiments, the at least one memory and the program code are configured to, with the at least one processor, cause the apparatus to generate the technology operations incident nature classification by processing the technology operations incident event using a technology operations incident event classification model.

In some embodiments, the technology operations incident event classification model includes a support vector machine learning model.

In some embodiments, the at least one memory and the program code are configured to, with the at least one processor, cause the apparatus to access one or more development resource reference unit training vectors.

In some embodiments, the at least one memory and the program code are configured to, with the at least one processor, cause the apparatus to train a development resource reference unit assessment model using the one or more development resource reference unit training vectors.

In some embodiments, the at least one memory and the program code are configured to, with the at least one processor, cause the apparatus to generate a development resource reference unit impact value by applying resource reference unit data to the development resource reference unit evaluation model.

In some embodiments, the at least one memory and the program code are configured to, with the at least one processor, cause the apparatus to access development resource reference unit data representative of a development resource reference unit.

In some embodiments, the at least one memory and the program code are configured to, with the at least one processor, cause the apparatus to generate a development resource reference unit embedding vector based at least in part on the development resource reference unit data, the development resource reference unit embedding vector corresponding to the development resource reference unit.

In some embodiments, the at least one memory and the program code are configured to, with the at least one processor, cause the apparatus to store the development resource reference unit embedding vector.

In some embodiments, the development resource reference unit embedding vector is stored in a development resource reference unit embedding vector repository based at least in part on a development resource reference unit nature.

In some embodiments, the development resource reference unit embedding vector is indicative of a development resource reference unit identifier, a development resource reference unit link, a development resource reference unit nature, and development resource reference unit fragment.

In some embodiments, generating the development resource reference unit embedding vector includes processing the development resource reference unit data using a fragment extraction model to generate a development resource reference unit fragment.

In some embodiments, generating the development resource reference unit embedding vector includes processing the development resource reference unit fragment using one or more embedding and indexing operations.

In some embodiments, the at least one memory and the program code are configured to, with the at least one processor, cause the apparatus to the development resource reference unit embedding vector includes processing the development resource reference unit data using a nature extraction model to generate a development resource reference unit nature.

In some embodiments, processing the candidate development resource reference unit fragment using the technology operations incident responsive direction generation model includes the program code being further configured to, with the at least one processor, cause the apparatus to perform one or more retrieval augment generation operations.

In some embodiments, the at least one memory and the program code are configured to, with the at least one processor, cause the apparatus to rank the candidate development resource reference unit embedding vector and one or more other candidate development resource reference unit embedding vector using a candidate development resource reference unit embedding vector ranking model.

In some embodiments, the at least one memory and the program code are configured to, with the at least one processor, cause the apparatus to train the candidate development resource reference unit embedding vector ranking model using one or more reinforcement learning operations.

In some embodiments, generating the candidate development resource reference unit structure includes performing one or more retrieval operations.

In accordance with some exemplary embodiments of the present disclosure, an example method for outputting a resource development generation interface component to a resource operational interface is provided. In some embodiments, the method includes identifying a technology operations incident event. In some embodiments, the method includes filtering a plurality of development resource reference unit embedding vectors based at least in part on a technology operations incident nature classification associated with the technology operations incident event to identify a candidate development resource reference unit embedding vector. In some embodiments, the method includes generating a candidate development resource reference unit structure based at least in part on the candidate development resource reference unit embedding vector. In some embodiments, the candidate development resource reference unit structure includes a candidate development resource reference unit fragment and a candidate development resource reference unit link. In some embodiments, the method includes generating a candidate technology operations incident responsive direction by processing the candidate development resource reference unit fragment using a technology operations incident responsive direction generation model. In some embodiments, the method includes generating a technology operations incident event response interface component comprising the candidate development resource reference unit structure and the candidate technology operations incident responsive direction. In some embodiments, the method includes outputting the technology operations incident event response interface component for rendering to a technology operations incident event response interface.

In some embodiments, the method includes generating the technology operations incident nature classification by processing the technology operations incident event using a technology operations incident event classification model.

In some embodiments, the method includes accessing development resource reference unit data representative of a development resource reference unit.

In some embodiments, the method includes generating a development resource reference unit embedding vector based at least in part on the development resource reference unit data, the development resource reference unit embedding vector corresponding to the development resource reference unit.

In some embodiments, the method includes storing the development resource reference unit embedding vector.

In some embodiments, the development resource reference unit embedding vector is indicative of a development resource reference unit identifier, a development resource reference unit link, a development resource reference unit nature, and development resource reference unit fragment.

In some embodiments, generating the development resource reference unit embedding vector includes processing the development resource reference unit data using a fragment extraction model to generate a development resource reference unit fragment.

In some embodiments, generating the development resource reference unit embedding vector includes processing the development resource reference unit fragment using one or more embedding and indexing operations.

In accordance with another exemplary embodiment of the present disclosure, a computer program product for outputting a resource development generation interface component to a resource operational interface is provided. In some embodiments, the computer program product includes at least one non-transitory computer-readable storage medium having computer-readable program code portions stored therein, the computer-readable program code portions comprising an executable portion. In some embodiments, the computer-readable program code portions comprising an executable portion are configured to identify a technology operations incident event. In some embodiments, the computer-readable program code portions comprising an executable portion are configured to filter a plurality of development resource reference unit embedding vectors based at least in part on a technology operations incident nature classification associated with the technology operations incident event to identify a candidate development resource reference unit embedding vector. In some embodiments, the computer-readable program code portions comprising an executable portion are configured to generate a candidate development resource reference unit structure based at least in part on the candidate development resource reference unit embedding vector. In some embodiments, the candidate development resource reference unit structure includes a candidate development resource reference unit fragment and a candidate development resource reference unit link. In some embodiments, the computer-readable program code portions comprising an executable portion are configured to generate a candidate technology operations incident responsive direction by processing the candidate development resource reference unit fragment using a technology operations incident responsive direction generation model. In some embodiments, the computer-readable program code portions comprising an executable portion are configured to generate a technology operations incident event response interface component comprising the candidate development resource reference unit structure and the candidate technology operations incident responsive direction. In some embodiments, the computer-readable program code portions comprising an executable portion are configured to output the technology operations incident event response interface component for rendering to a technology operations incident event response interface.

In accordance with some exemplary embodiments of the present disclosure, an example apparatus for outputting a development resource reference unit impact interface component to a development resource reference unit interface is provided. In some embodiments, the apparatus may comprise at least one processor and at least one memory including program code. In some embodiments, the at least one memory and the program code are configured to, with the at least one processor, cause the apparatus to access development resource reference unit data representative of a development resource reference unit. In some embodiments, the at least one memory and the program code are configured to, with the at least one processor, cause the apparatus to generate a development resource reference unit impact evaluation factor set based at least in part on the development resource reference unit data, the development resource reference unit impact evaluation factor set comprising at least one development resource reference unit evaluation factor. In some embodiments, the at least one memory and the program code are configured to, with the at least one processor, cause the apparatus to generate a development resource reference unit impact value for the development resource reference unit based at least in part on the development resource reference unit impact evaluation factor set. In some embodiments, the at least one memory and the program code are configured to, with the at least one processor, cause the apparatus to generate a development resource reference unit impact interface component comprising the development resource reference unit impact value. In some embodiments, the at least one memory and the program code are configured to, with the at least one processor, cause the apparatus to output the development resource reference unit impact interface component for rendering to a development resource reference unit interface.

In some embodiments, generating the development resource reference unit impact evaluation factor set includes the program code being further configured to, with the at least one processor, further cause the apparatus to generate an acceptance development resource reference unit evaluation factor by performing an acceptance operation using the development resource reference unit data.

In some embodiments, generating the development resource reference unit impact evaluation factor set includes the program code being further configured to, with the at least one processor, further cause the apparatus to generate a resolution event development resource reference unit evaluation factor by performing a resolution event operation using the development resource reference unit data.

In some embodiments, generating the development resource reference unit impact evaluation factor set includes the program code being further configured to, with the at least one processor, further cause the apparatus to generate a recency development resource reference unit evaluation factor by performing a recency operation using the development resource reference unit data.

In some embodiments, the at least one memory and the program code are configured to, with the at least one processor, cause the apparatus to determine that the development resource reference unit impact value is below a development resource reference unit impact value threshold.

In some embodiments, the at least one memory and the program code are configured to, with the at least one processor, cause the apparatus to, in response to determining that the development resource reference unit impact value is below the development resource reference unit impact value threshold, configure the development resource reference unit impact interface component to visually distinguish the development resource reference unit impact value

In some embodiments, the at least one memory and the program code are configured to, with the at least one processor, cause the apparatus to initiate performance of one or more impact value responsive actions based at least in part on the development resource reference unit impact value.

In some embodiments, initiating performance of one or more impact value responsive actions includes the program code being further configured to, with the at least one processor, further cause the apparatus to initiate performance of one or more impact value responsive alert actions.

In some embodiments, initiating performance of one or more impact value responsive actions includes the program code being further configured to, with the at least one processor, further cause the apparatus to initiate performance of one or more impact value responsive disablement actions.

In some embodiments, initiating performance of one or more impact value responsive actions includes the program code being further configured to, with the at least one processor, further cause the apparatus to initiate performance of one or more impact value responsive positioning actions.

In some embodiments, the development resource reference unit is stored in a development resource reference unit repository.

In some embodiments, the at least one memory and the program code are configured to, with the at least one processor, cause the apparatus to access one or more development resource reference unit training vectors

In some embodiments, the at least one memory and the program code are configured to, with the at least one processor, cause the apparatus to train a development resource reference unit assessment model using the one or more development resource reference unit training vectors.

In some embodiments, the at least one memory and the program code are configured to, with the at least one processor, cause the apparatus to generate a second development resource reference unit impact value by applying resource reference unit data to the development resource reference unit evaluation model.

In accordance with another exemplary embodiment of the present disclosure, a method for outputting a development resource reference unit impact interface component to a development resource reference unit interface is provided. In some embodiments, the method includes accessing development resource reference unit data representative of a development resource reference unit. In some embodiments, the method includes generating a development resource reference unit impact evaluation factor set based at least in part on the development resource reference unit data, the development resource reference unit impact evaluation factor set comprising at least one development resource reference unit evaluation factor. In some embodiments, the method includes generating a development resource reference unit impact value for the development resource reference unit based at least in part on the development resource reference unit impact evaluation factor set. In some embodiments, the method includes generating a development resource reference unit impact interface component comprising the development resource reference unit impact value. In some embodiments, the method includes outputting the development resource reference unit impact interface component for rendering to a development resource reference unit interface.

In some embodiments, generating the development resource reference unit impact evaluation factor includes generating an acceptance development resource reference unit evaluation factor by performing an acceptance operation using the development resource reference unit data.

In some embodiments, generating the development resource reference unit impact evaluation factor includes generating a resolution event development resource reference unit evaluation factor by performing a resolution event operation using the development resource reference unit data.

In some embodiments, generating the development resource reference unit impact evaluation factor includes generating a recency development resource reference unit evaluation factor by performing a recency operation using the development resource reference unit data.

In some embodiments, the method includes initiating performance of one or more impact value responsive actions based at least in part on the development resource reference unit impact value.

In some embodiments, initiating performance of one or more impact value responsive actions includes initiating performance of one or more impact value responsive alert actions.

In some embodiments, initiating performance of one or more impact value responsive actions includes initiating performance of one or more impact value responsive disablement actions.

In some embodiments, initiating performance of one or more impact value responsive actions includes initiating performance of one or more impact value responsive positioning actions.

In accordance with another exemplary embodiment of the present disclosure, a computer program product for outputting a development resource reference unit impact interface component to a development resource reference unit interface is provided. In some embodiments, the computer program product includes at least one non-transitory computer-readable storage medium having computer-readable program code portions stored therein, the computer-readable program code portions comprising an executable portion. In some embodiments, the computer-readable program code portions comprising an executable portion are configured to access development resource reference unit data representative of a development resource reference unit. In some embodiments, the computer-readable program code portions comprising an executable portion are configured to generate a development resource reference unit impact evaluation factor set based at least in part on the development resource reference unit data, the development resource reference unit impact evaluation factor set comprising at least one development resource reference unit evaluation factor. In some embodiments, the computer-readable program code portions comprising an executable portion are configured to generate a development resource reference unit impact value for the development resource reference unit based at least in part on the development resource reference unit impact evaluation factor set. In some embodiments, the computer-readable program code portions comprising an executable portion are configured to generate a development resource reference unit impact interface component comprising the development resource reference unit impact value. In some embodiments, the computer-readable program code portions comprising an executable portion are configured to output the development resource reference unit impact interface component for rendering to a development resource reference unit interface.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms above, non-limiting and non-exhaustive embodiments of the subject disclosure will now be described with reference to the accompanying drawings which are not necessarily drawn to scale. The components illustrated in the accompanying drawings may or may not be present in certain embodiments described herein. Some embodiments may include fewer (or more) components than those shown in the figures in accordance with an example embodiment of the present disclosure.

FIG. 1 illustrates an example development resource and technology operations system configured to communicate with various client devices in accordance with various example embodiments of the present disclosure;

FIG. 2 depicts a schematic block diagram of example circuitry to perform various operations in accordance with various example embodiments of the present disclosure;

FIG. 3 illustrates an example architecture of a development resource and technology operations system in accordance with various example embodiments of the present disclosure;

FIG. 4 illustrates an example visualization of a development resource reference unit in accordance with various example embodiments of the present disclosure;

FIG. 5 illustrates an example development resource reference unit interface in accordance with various example embodiments of the present disclosure;

FIG. 6 illustrates an example technology operations incident event response interface in accordance with various example embodiments of the present disclosure;

FIG. 7 depicts a flowchart diagram illustrating example operations for outputting a development resource reference unit impact interface component in accordance with an example embodiment of the present disclosure;

FIG. 8 depicts a flowchart diagram illustrating example operations for generating one or more development resource reference unit evaluation factors in accordance with an example embodiment of the present disclosure;

FIG. 9 depicts a flowchart diagram illustrating example operations for initiating performance of one or more impact value responsive actions in accordance with an example embodiment of the present disclosure;

FIG. 10 depicts flowchart diagram illustrating example operations for outputting a technology operations incident event response interface component in accordance with an example embodiment of the present disclosure; and

FIG. 11 depicts flowchart diagram illustrating example operations for generating a development resource reference unit embedding vector in accordance with an example embodiment of the present disclosure.

### DETAILED DESCRIPTION

Example embodiments now will be more fully described with reference to the accompanying drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details. It should be understood that some, but not all embodiments of the present disclosure are shown and described herein. Indeed, embodiments of the disclosure may be embodied in many different forms, and accordingly this disclosure should not be construed as limited to the embodiments set forth herein; rather, these embodiments are provided so that this disclosure will satisfy applicable legal requirements.

### Overview

Methods, apparatuses, systems, and computer program products are provided in accordance with example embodiments of the present disclosure in order to enable efficient, reliable, dynamic, and secure generation of development resource reference unit impact values, candidate development resource reference unit structures, candidate technology operations incident responsive directions, and provisioning of various interface components, such as a development resource reference unit impact interface component and a technology operations incident event response interface component, based on development resource reference unit data.

Software development systems (e.g., Jira Software® or Jira Service Management® by Atlassian) enable enterprises to plan, track, organize, schedule, address, repair, diagnose, execute, modify, transmit, and/or otherwise manage enterprise operations. In an agile development resource and technology operations environment, it is desirable for software developments systems to leverage development resource reference units in order to enable efficient and dynamic enterprise operations. For example, in an agile development resource and technology operations environment it is desirable to leverage a large number of development resource reference units to enable dynamic software development and resolve a variety of software development roadblocks in an efficient and accurate manner. However, many software development systems are associated with non-agile environments and, as a result, are simplistic and lack development resource reference unit evaluation and technology operations incident event response capabilities. Thus, many software development systems have limited ability to leverage development resource reference unit evaluation and technology operations incident event response capabilities because such software development systems are unable to rely on development resource reference units. As a result, it is not possible for software development systems to efficiently, dynamically, and reliably enable enterprise operations in an agile development resource and technology operations environment.

In some examples, software development systems are not able to dynamically and efficiently enable enterprise operations in a development resource and technology operations environment because such software development systems are not able to automatically evaluate a large number of development resource reference units. In some examples, software development systems are not able to dynamically and efficiently enable enterprise operations in a development resource and technology operations environment because such software development systems are not able to automatically implement impact value responsive actions based on development resource reference unit impact values. For example, such software development systems are not able to automatically implement impact value responsive actions based on development resource reference unit impact values that fail to satisfy a development resource reference unit impact value thresholds.

In some examples, software development systems are not able to dynamically and efficiently enable enterprise operations in a development resource and technology operations environment because such software development systems are not able to automatically generate development resource reference unit embedding vectors based on development resource reference unit data. In some examples, software development systems are not able to dynamically and efficiently enable enterprise operations in a development resource and technology operations environment because such software development systems are not able to automatically leverage development resource reference units for responding to and/or resolving technology operations incident events. In some examples, software development systems are not able to dynamically and efficiently enable enterprise operations in a development resource and technology operations environment because such software development systems are not able to provide interface components configured to convey development resource reference unit impact values, candidate development resource reference unit structures, and candidate technology operations incident responsive directions, associated with development resource reference units.

In order to address these technical challenges, the inventors have determined that it is desirable to implement a development resource and technology operations system to generate a development resource reference unit impact value for a development resource reference unit based on a development resource reference unit impact evaluation factor set. A development resource reference unit impact value may be indicative of a determined measure of a usefulness of a development resource reference unit for performing one or more functions, actions, operations, and/or the like. As a result, the development resource and technology operations system enables the dynamic and efficient implementation of enterprise operations by providing automatic evaluation of development resource reference units. In this way, a large number of development resource reference units may be leveraged for enabling enterprise operations in a reliable and efficient manner in an agile development resource and technology operations environment.

In order to address these technical challenges, the inventors have determined that it is desirable to implement a development resource and technology operations system to initiate performance of one or more impact value responsive actions. A development resource and technology operations system may initiate performance of one or more impact value responsive actions to remedy development resource reference units that fail to satisfy a development resource reference unit impact value thresholds. For example, a development resource and technology operations system may initiate performance of an impact value responsive alert action that includes transmitting an alert associated with a development resource reference unit impact value. As a result, the development resource and technology operations system enables the dynamic and efficient implementation of enterprise operations in an agile development resource and technology operations environment by automatically performing impact value responsive actions based on development resource reference unit impact values.

In order to address these technical challenges, the inventors have determined that it is desirable to implement a development resource and technology operations system to generate development resource reference unit embedding vectors associated with development resource reference units based on development resource reference unit data. In this way, a large number of development resource reference units may be leveraged by enabling semantic searching of development resource reference unit embedding vectors. As a result, the development resource and technology operations system enables the dynamic and efficient implementation of enterprise operations in an agile development resource and technology operations environment by generating development resource reference unit embedding vectors.

In order to address these technical challenges, the inventors have determined that it is desirable to implement a development resource and technology operations system to generate candidate development resource reference unit structures and/or candidate technology operations incident responsive directions for responding to technology operations incident events. As a result, the development resource and technology operations system enables leveraging development resource reference units in an agile development resource and technology operations environment by automatically generating candidate development resource reference unit structures and/or candidate technology operations incident responsive directions.

In order to address these technical challenges, the inventors have determined that it is desirable to implement a development resource and technology operations system to generate a development resource reference unit impact interface component and/or a technology operations incident event response interface component. A development resource reference unit impact interface component may be configured to convey development resource reference unit impact values associated with development resource reference units. A technology operations incident event response interface component may be configured to convey candidate development resource reference unit structures and/or candidate technology operations incident responsive directions. As a result, the development resource and technology operations system enables the dynamic and efficient implementation of enterprise operations in an agile development resource and technology operations environment by providing an efficient dissemination of development resource reference units.

### Definitions

The following explanations of terms are provided to better describe the present disclosure and to guide those of ordinary skill in the art in the practice of the present disclosure.

As used herein, the term “development resource and technology operations system” refers to the software platform(s) and associated hardware configured to support and maintain a plurality of projects, workflows, and all associated functionality. For example, a development resource and technology operations system may comprise a software product such as Jira® by Atlassian®. Example development resource and technology operations systems comprise supporting server(s) and repositor(ies), and in some embodiments, are further configured to engage with internal resources, external resources, internal applications, and/or external applications.

As used herein, the term “development resource and technology operations server” refers to a software platform and associated hardware that is configured to, inter alia, manage the various interfaces and/or interface components and associated functionality of the development resource and technology operations system. For example, in some embodiments, the development resource and technology operations server is configured to generate, manage, output, and/or update development resource reference unit impact interface components, development resource reference unit interface components, and/or technology operations incident event response interface components.

As another example, in some embodiments, the development resource and technology operations server is configured to receive, identify, determine, generate, and/or output development resource reference unit data, development resource reference unit impact evaluation factor sets, development resource reference unit characteristic sets, technology operations incident events, development resource reference units, maximum development resource reference units, development resource reference unit embedding vectors, candidate development resource reference unit embedding vectors, development resource reference unit impact values, development resource reference unit impact value thresholds, candidate development resource reference unit structures, candidate technology operations incident responsive directions.

As another example, in some embodiments, the development resource and technology operations server is configured to generate, perform, cause, initiate, and/or implement impact value responsive actions, acceptance operations, resolution event operations, recency operations, retrieval augment generation operations, and/or reinforcement learning operations.

As used herein, the term “development resource and technology operations repository” refers to a location, such as a database stored on a memory device, which is accessible by one or more computing devices for retrieval and storage of data associated with the development resource and technology operations system. For example, the development resource and technology operations repository may include development resource reference unit impact evaluation factor sets, development resource reference unit impact values, development resource reference unit impact value thresholds, candidate development resource reference unit structures, candidate technology operations incident responsive directions, and/or the like. The development resource and technology operations repository may be a dedicated device and/or part of a larger repository. The development resource and technology operations repository may be dynamically updated or be static. In some embodiments, the development resource and technology operations repository is encrypted in order to limit unauthorized access of data associated with the development resource and technology operations system.

As used herein, the term “development resource reference unit repository” refers to a location, such as a database stored on a memory device, which is accessible by one or more computing devices for retrieval and storage of data associated with the development resource and technology operations system. For example, the development resource reference unit repository may include development resource reference unit data, development resource reference units, maximum development resource reference units, development resource reference unit characteristic sets, and/or the like. The development resource reference unit repository may be a dedicated device and/or part of a larger repository. The development resource reference unit repository may be dynamically updated or be static. In some embodiments, the development resource reference unit repository is encrypted in order to limit unauthorized access of data associated with the development resource and technology operations system.

As used herein, the term “development resource reference unit embedding vector repository” refers to a location, such as a database stored on a memory device, which is accessible by one or more computing devices for retrieval and storage of data associated with the development resource and technology operations system. For example, the development resource reference unit embedding vector repository may include development resource reference unit embedding vectors, candidate development resource reference unit embedding vectors, and/or the like. In some embodiments, a development resource reference unit embedding vector repository includes a hierarchical structure. In this regard, for example, a development resource reference unit embedding vector may be stored in a development resource reference unit embedding vector repository in accordance with a development resource reference unit nature associated with the development resource reference unit embedding vector. In this way, for example, a brute force technique is not needed to search a development resource reference unit embedding vector repository because development resource reference unit embedding vectors may be filtered based on a technology operations incident nature classification. For example, development resource reference unit embedding vectors may be filtered based on a technology operations incident nature classification that corresponds to a development resource reference unit nature associated with the development resource reference unit embedding vectors. The development resource reference unit embedding vector repository may be a dedicated device and/or part of a larger repository. The development resource reference unit embedding vector repository may be dynamically updated or be static. In some embodiments, the development resource reference unit embedding vector repository is encrypted in order to limit unauthorized access of data associated with the development resource and technology operations system.

As used herein, the terms “development resource and technology operations application” or “development resource and technology operations app” refer to a dedicated software program, application, platform, service, web browser, or computer-executable application software programmed or configured to run on a client device which provides a user access to the development resource and technology operations system and its associated functionality. In some embodiments, the development resource and technology operations application may include hardware, software, or combinations thereof operating remotely (e.g., on a server). In some embodiments, the development resource and technology operations application is designed to execute on mobile devices, such as tablets or smartphones. For example, in certain embodiments, an app is provided that executes on mobile device operating systems such as iOS®, Android™, or Windows®. These platforms typically provide frameworks that allow apps to communicate with one another and with particular hardware and software components of mobile devices. For example, the mobile operating systems named above each provide frameworks for interacting with location services circuitry, wired and wireless network interfaces, user contacts, and other applications. Communication with hardware and software modules executing outside of the app is typically provided via application programming interfaces (APIs) provided by the mobile device operating system.

As used herein, the term “development resource reference unit” refers to a unit of information used for performing one or more functions, actions, operations, and/or the like. For example, a development resource reference unit may be used for responding to and/or resolving a technology operations incident event associated with a development resource and technology operations server. In this regard, for example, a development resource reference unit may include critical resource development and technology operations information that provides step by step instructions for resolving technology operations incident events. In some embodiments, a development resource reference unit is associated with a development resource reference unit characteristic set. In some embodiments, a development resource reference unit is stored in a development resource reference unit repository.

As used herein, the term “development resource reference unit data” refers to a one or more items of data representative of and/or associated with a development resource reference unit. Additionally, or alternatively, development resource reference unit data may be one or more items of data representative of and/or associated with a development resource reference unit characteristic set associated with a development resource reference unit. In some embodiments, development resource reference unit data is stored in a development resource reference unit repository.

As used herein, the term “development resource reference unit characteristic set” refers to one or more items of data representative of and/or associated with characteristics of a development resource reference unit. In some embodiments, a development resource reference unit characteristic set includes a development resource reference unit positive impression value. In some embodiments, a development resource reference unit characteristic set includes a development resource reference unit negative impression value. In some embodiments, a development resource reference unit characteristic set includes a development resource reference unit update timestamp. In some embodiments, a development resource reference unit characteristic set includes a development resource reference unit resolution event metric. In some embodiments, a development resource reference unit characteristic set includes a development resource reference unit identifier. In some embodiments, a development resource reference unit characteristic set includes a development resource reference unit link. In some embodiments, a development resource reference unit characteristic set includes a maximum development resource reference unit resolution event metric. In some embodiments, a development resource reference unit characteristic set includes a development resource reference unit nature.

As used herein the term “development resource reference unit positive impression value” refers to a data value representing a measured number of times a development resource reference unit has received a positive rating by a development resource and technology operations system and/or a user associated with a development resource and technology operations system. For example, a development resource reference unit positive impression value may be a data value representing a measured number of times a development resource reference unit has received a positive rating after being used to respond to and/or resolve a technology operations incident event.

As used herein the term “development resource reference unit negative impression value” refers to a data value representing a measured number of times a development resource reference unit has received a negative rating by a development resource and technology operations system and/or a user associated with a development resource and technology operations system. For example, a development resource reference unit negative impression value may be a data value representing a measured number of times a development resource reference unit has received a negative rating after being used to respond to and/or resolve a technology operations incident event.

As used herein the term “development resource reference unit update timestamp” refers to a data value representing a time at which a development resource reference unit was last updated.

As used herein the term “development resource reference unit resolution event metric” refers to a data value representing a measured number of times a development resource reference unit has been used for resolving one or more incidents. For example, a development resource reference unit resolution event metric may be a data value representing a measured number of times a development resource reference unit has been used for resolving a technology operations incident event.

As used herein the term “maximum development resource reference unit” refers to a unit of information used for performing one or more functions, actions, operations, and/or the like associated with the highest development resource reference unit resolution event metric out of a plurality of development resource reference units. In some embodiments, a maximum development resource reference unit is stored in a development resource reference unit repository.

As used herein the term “maximum development resource reference unit resolution event metric” refers to a data value representing a measured number of times a maximum development resource reference unit has been used for resolving one or more incidents. For example, a maximum development resource reference unit resolution event metric may be a data value representing a measured number of times a maximum development resource reference unit has been used for resolving one or more technology operations incident events.

As used herein the term “development resource reference unit identifier” refers to one or more items of data by which a development resource reference unit is uniquely identified in a development resource and technology operations system, a development resource reference unit repository, a development resource reference unit embedding vector repository, and/or the like. A development resource reference unit identifier may comprise one or more of ASCII text, encryption keys, identification certificates, a pointer, an IP address, a URL, a MAC address, a memory address, or other unique identifier, or combinations thereof.

As used herein the term “development resource reference unit link” refers to a data object that facilitates access to a development resource reference unit. For example, a development resource reference unit link may facilitate access to a development resource reference unit from a location other than where the development resource reference unit is stored and/or hosted. In this regard, for example, a development resource reference unit link may facilitate access to a development resource reference unit from a client device, a software development tool, and/or the like.

As used herein, the term “development resource reference unit impact value” refers to a data value representative of a determined measure of a usefulness of a development resource reference unit for performing one or more functions, actions, operations, and/or the like. For example, a development resource reference unit impact value may be a data value representative of a determined measure of a usefulness of a development resource reference unit for performing one or more functions, actions, operations, and/or the like for responding to and/or resolving a technology operations incident event. In some embodiments, a development resource reference unit impact value is based at least in part on a development resource reference unit impact evaluation factor set. For example, a development resource reference unit impact evaluation factor set may be based on a combination of one or more development resource reference unit evaluation factors in a development resource reference unit impact evaluation factor set. In some embodiments, a development resource reference unit impact value is stored in a development resource and technology operations repository.

As used herein, the term “development resource reference unit impact value threshold” refers to a parameter, condition, value, and/or the like that defines criteria that a development resource reference unit impact value must satisfy, achieve, and/or meet. In some embodiments, when a development resource reference unit impact value does not meet a development resource reference unit impact value threshold (e.g., a development resource reference unit impact value is below a development resource reference unit impact value threshold) a development resource and technology operations system may initiate performance of one or more impact value responsive actions. In some embodiments, when a development resource reference unit impact value does not meet a development resource reference unit impact value threshold (e.g., a development resource reference unit impact value is below a development resource reference unit impact value threshold) a development resource and technology operations system may configure a development resource reference unit impact interface component to visually distinguish the development resource reference unit impact value. In some embodiments, a development resource reference unit impact value threshold is stored in a development resource and technology operations repository.

As used herein, the term “development resource reference unit impact evaluation factor set” refers to one or more items of data representative of and/or associated with a set of one or more development resource reference unit evaluation factors. In some embodiments, a development resource reference unit impact evaluation factor set may be based at least in part on development resource reference unit data. In some embodiments, a development resource reference unit impact evaluation factor set is stored in a development resource and technology operations repository.

As used herein, the term “development resource reference unit evaluation factor” refers to a data value representative of a subsidiary determined measure of a usefulness of a development resource reference unit for performing one or more functions, actions, operations, and/or the like. For example, a development resource reference unit evaluation factor may be a data value representative of a subsidiary determined measure of a usefulness of a development resource reference unit for performing one or more functions, actions, operations, and/or the like for responding to and/or resolving a technology operations incident event.

In some embodiments, a development resource reference unit evaluation factor includes an acceptance development resource reference unit evaluation factor. Additionally, or alternatively, a development resource reference unit evaluation factor includes a resolution event development resource reference unit evaluation factor. Additionally, or alternatively, a development resource reference unit evaluation factor includes a recency development resource reference unit evaluation factor.

As used herein, the term “acceptance development resource reference unit evaluation factor” refers to a data value representative of a subsidiary determined measure of a usefulness of a development resource reference unit for performing one or more functions, actions, operations, and/or the like that is determined based on a development resource reference unit positive impression value and/or a development resource reference unit negative impression value. For example, an acceptance development resource reference unit evaluation factor may be a data value representative of a subsidiary determined measure of a usefulness of a development resource reference unit for performing one or more functions, actions, operations, and/or the like for responding to and/or resolving a technology operations incident event that is determined based on a development resource reference unit positive impression value and/or a development resource reference unit negative impression value. In this regard, for example, an acceptance development resource reference unit evaluation factor may be a subsidiary component of a development resource reference unit impact value.

In some embodiments, an acceptance development resource reference unit evaluation factor may be generated by performing an acceptance operation using development resource reference unit data. For example, an acceptance development resource reference unit evaluation factor may be generated by performing an acceptance operation using a development resource reference unit positive impression value and/or a development resource reference unit negative impression value.

As used herein, the term “resolution event development resource reference unit evaluation factor” refers to a data value representative of a subsidiary determined measure of a usefulness of a development resource reference unit for performing one or more functions, actions, operations, and/or the like that is determined based on a development resource reference unit resolution event metric. For example, a resolution event development resource reference unit evaluation factor may be a data value representative of a subsidiary determined measure of a usefulness of a development resource reference unit for performing one or more functions, actions, operations, and/or the like for responding to and/or resolving a technology operations incident event that is determined based on a development resource reference unit resolution event metric. In this regard, for example, a resolution event development resource reference unit evaluation factor may be a subsidiary component of a development resource reference unit impact value.

In some embodiments, a resolution event development resource reference unit evaluation factor may be generated by performing a resolution event operation using development resource reference unit data. For example, a resolution event development resource reference unit evaluation factor may be generated by performing a resolution event operation using a development resource reference unit resolution event metric.

As used herein, the term “recency development resource reference unit evaluation factor” refers to a data value representative of a subsidiary determined measure of a usefulness of a development resource reference unit for performing one or more functions, actions, operations, and/or the like that is determined based on a development resource reference unit update timestamp. For example, a recency development resource reference unit evaluation factor may be a data value representative of a subsidiary determined measure of a usefulness of a development resource reference unit for performing one or more functions, actions, operations, and/or the like for responding to and/or resolving a technology operations incident event that is determined based on a development resource reference unit update timestamp. In this regard, for example, a recency development resource reference unit evaluation factor may be a subsidiary component of a development resource reference unit impact value.

In some embodiments, a recency development resource reference unit evaluation factor may be generated by performing a recency operation using development resource reference unit data. For example, a recency development resource reference unit evaluation factor may be generated by performing a recency operation using a development resource reference unit update timestamp.

As used herein, the term “acceptance operation” refers to a data object that provides acceptance commands, acceptance techniques, acceptance directives, and/or acceptance specifications for generating an acceptance development resource reference unit evaluation factor using development resource reference unit data. In this regard, for example, an acceptance operation may be a data object that provides acceptance commands, acceptance techniques, acceptance directives, and/or acceptance specifications for generating an acceptance development resource reference unit evaluation factor using the following equation:

$$A ( ζ , t ) = Sigmoid ( C * \frac{P ( ζ , t ) - N ( ζ , t )}{P ( ζ , t ) + N ( ζ , t ) - ϵ} , where Sigmoid ( x ) = \frac{{e}^{x}}{1 + {e}^{x}}$$

where A is an acceptance development resource reference unit evaluation factor, P is a development resource reference unit positive impression value, N is a development resource reference unit positive impression value, C is a constant (e.g., 4), ϵ is a small constant (e.g., 10⁻⁹), ζ is a rolling time window of days, and t is time.

As used herein, the term “recency operation” refers to a data object that provides recency commands, recency techniques, recency directives, and/or recency specifications for generating a recency development resource reference unit evaluation factor using development resource reference unit data. In this regard, for example, a recency operation may be a data object that provides recency commands, recency techniques, recency directives, and/or recency specifications for generating a recency development resource reference unit evaluation factor using the following equation:

$$R ( ζ , t ) = 1 - ( \frac{t}{F * K * ζ} )$$

where R is a recency development resource reference unit evaluation factor, F is a penalization factor, K is a number of rolling time windows, ζ is a rolling time window of days (e.g., an amount of time that has passed), and t is time.

As used herein, the term “resolution event operation” refers to a data object that provides resolution event commands, resolution event techniques, resolution event directives, and/or resolution event specifications for generating a resolution event development resource reference unit evaluation factor using development resource reference unit data. In this regard, for example, a resolution event operation may be a data object that provides resolution event commands, resolution event techniques, resolution event directives, and/or resolution event specifications for generating a resolution event development resource reference unit evaluation factor using the following equation:

$$RE ( ζ , t ) = \frac{log ( 1 + U ( ζ , t ) )}{log ( 1 + M ( ζ , t ) )}$$

where RE is a resolution event development resource reference unit evaluation factor, U is a development resource reference unit resolution event metric, ζ is a rolling time window of days, and t is time, and M is a maximum development resource reference unit resolution event metric.

As used herein, the term “impact value responsive action” refers to an actionable item, work item, issue, and/or task that may be performed by a development resource and technology operations server and/or a user associated with a development resource and technology operations server. In some embodiments, an impact value responsive action includes an impact value responsive alert action, an impact value responsive disablement action, and/or an impact value responsive positioning action.

As used herein, the term “impact value responsive alert action” refers to an alert actionable item, alert work item, alert issue, and/or alert task that may be performed by a development resource and technology operations server and/or a user associated with a development resource and technology operations server. In some embodiments, an impact value responsive alert action includes generating and/or transmitting an alert to a user associated with a development resource and technology operations server when a development resource reference unit impact value is below a development resource reference unit impact value threshold. For example, an impact value responsive alert action may include generating and/or transmitting an alert to a user who generated a development resource reference unit indicating that the development resource reference unit needs to be updated.

As used herein, the term “impact value responsive disablement action” refers to a disablement actionable item, disablement work item, disablement issue, and/or disablement task that may be performed by a development resource and technology operations server and/or a user associated with a development resource and technology operations server. In some embodiments, an impact value responsive disablement action includes disabling a development resource reference unit such that the development resource reference unit can no longer be accessed by a development resource and technology operations server and/or a user associated with a development resource and technology operations server. For example, an impact value responsive disablement action may include disabling a development resource reference unit when a development resource reference unit impact value is below a development resource reference unit impact value threshold.

As used herein, the term “impact value responsive positioning action” refers to a positioning actionable item, positioning work item, positioning issue, and/or positioning task that may be performed by a development resource and technology operations server and/or a user associated with a development resource and technology operations server. In some embodiments, an impact value responsive positioning action includes changing a positioning of a development resource reference unit in a ranking of a plurality of development resource reference units. For example, an impact value responsive positioning action may include changing a positioning of a development resource an impact value responsive positioning action when a development resource reference unit impact value is below a development resource reference unit impact value threshold. In some embodiments, an impact value responsive positioning action may be performed by a resource development and technology operations system using a candidate development resource reference unit embedding vector ranking model.

As used herein, the term “development resource reference unit interface” refers to a graphical user interface of a development resource and technology operations system that is configured to enable one or more users to view and engage with one or more development resource and technology operations system workspaces, views, and/or interface components. In some embodiments, for example, a development resource reference unit interface is configured to enable one or more users to view and engage with one or more development resource reference unit impact interface components and/or development resource reference unit interface components. In some embodiments, a development resource reference unit interface may be rendered to a client device based on data provided by development resource and technology operations server. In some embodiments, such data and instructions are facilitated by a dedicated software application running on the client device. In other embodiments, such data and instructions are provided through a web browser running on the client device.

As used herein, the term “development resource reference unit interface component” refers to a graphical user interface element that is rendered to, or as a portion of, a development resource reference unit interface of a development resource and technology operations system. In some embodiments, a development resource reference unit impact interface component is configured to display development resource reference unit data. In some embodiments, a development resource reference unit interface component may be rendered to a development resource reference unit interface such that the development resource reference unit interface component is proximate a development resource reference unit impact interface component.

As used herein, the term “development resource reference unit impact interface component” refers to a graphical user interface element that is rendered to, or as a portion of, a development resource reference unit interface of a development resource and technology operations system. In some embodiments, a development resource reference unit impact interface component is configured to display development resource reference unit impact values. In some embodiments, a development resource reference unit impact interface component may be rendered to a development resource reference unit interface such that the development resource reference unit impact interface component is proximate a development resource reference unit interface component. In some embodiments, a development resource reference unit impact interface component may be configured to visually distinguish a development resource reference unit impact value in response to a determination that a development resource reference unit impact value is below a development resource reference unit impact value threshold.

As used herein, the term “technology operations incident event” refers a data object that describes a problem, error, fault, and/or the like associated with a software application that requires analysis, diagnosis, repair, resolution, and/or the like by a development resource and technology operations system and/or a user associated with a development resource and technology operations system.

As used herein the term “development resource reference unit embedding vector” refers to a data object that corresponds to a development resource reference unit. In some embodiments, a development resource reference unit embedding vector is indicative of a development resource reference unit identifier associated with a development resource reference unit. In some embodiments, a development resource reference unit embedding vector is indicative of a development resource reference unit link associated with a development resource reference unit. In some embodiments, a development resource reference unit embedding vector is indicative of a development resource reference unit nature associated with a development resource reference unit. In some embodiments, a development resource reference unit embedding vector is indicative of a development resource reference unit fragment associated with a development resource reference unit. In some embodiments, a development resource reference unit embedding vector is indicative of a development resource reference unit impact value. In some embodiments, a development resource reference unit embedding vector is stored in a development resource reference unit embedding vector repository. In some embodiments, a development resource reference unit embedding vector is stored in a development resource reference unit embedding vector repository based at least in part on a development resource reference unit nature. In this way, for example, a brute force technique is not needed to filter for a candidate development resource reference unit embedding vector in a development resource reference unit embedding vector repository because development resource reference unit embedding vectors may be filtered based on a technology operations incident nature classification. For example, development resource reference unit embedding vectors may be filtered based on a technology operations incident nature classification that corresponds to a development resource reference unit nature associated with the development resource reference unit embedding vector.

As used herein, the term “development resource reference unit nature” refers to one or more items of data that describes a nature, intent, and/or classification of the content of a development resource reference unit. In some embodiments, a development resource reference unit nature corresponds to one or more technology operations incident nature classifications.

As used herein, the term “development resource reference unit fragment” refers to a portion of a development resource reference unit. In some embodiments, a development resource reference unit fragment includes text that is representative of a portion of a development resource reference unit.

As used herein the term “nature extraction model” refers to a data entity that describes parameters, hyper-parameters, and/or defined operations of a rules-based and/or machine learning model that is configured to generate a development resource reference unit nature. In some embodiments, a nature extraction model is configured to generate a development resource reference unit nature by processing development resource reference unit data.

As used herein the term “fragment extraction model” refers to a data entity that describes parameters, hyper-parameters, and/or defined operations of a rules-based and/or machine learning model that is configured to generate a development resource reference unit fragment. In some embodiments, a fragment extraction model is configured to generate a development resource reference unit fragment by processing development resource reference unit data.

As used herein the term “embedding and indexing operation” refers to a data object that provides embedding and indexing commands, embedding and indexing techniques, embedding and indexing directives, and/or embedding and indexing specifications. In some embodiments, an embedding and indexing operation includes converting a development resource reference unit fragment into a fixed length. For example, an embedding and indexing operation may include converting a development resource reference unit fragment into a fixed length using a universal sentence encoder. In some embodiments, an embedding and indexing operation includes embedding a development resource reference unit. In some embodiments, an embedding and indexing operation includes annotating a development resource reference unit fragment with a development resource reference unit nature. In some embodiments, an embedding and indexing operation includes storing a development resource reference unit embedding vector in a development resource reference unit embedding vector repository. In this regard, for example, an embedding and indexing operation may enable referencing of a development resource reference unit embedding vector of a plurality of development resource reference unit embedding vectors using a k-nearest neighbor algorithm.

As used herein, the term “technology operations incident event preprocessing model” refers to a data entity that describes parameters, hyper-parameters, and/or defined operations of a rules-based and/or machine learning model that is configured to perform preprocessing on a technology operations incident event. In some embodiments, a technology operations incident event preprocessing model may be configured to perform preprocessing on a technology operations incident event when the technology operations incident event is identified by a development resource and technology operations system. In some embodiments, a technology operations incident event preprocessing model may be configured to perform preprocessing on text associated with a technology operations incident event to convert the text from an unstandardized format to a standardized format.

As used herein the term “technology operations incident nature classification” refers to one or more items of data that describes a nature, intent, and/or classification of a technology operations incident event. In some embodiments, a technology operations incident nature classification corresponds to a development resource reference unit nature.

As used herein the term “technology operations incident event classification model” refers to a data entity that describes parameters, hyper-parameters, and/or defined operations of a rules-based and/or machine learning model that is configured to generate a technology operations incident nature classification. In some embodiments, a technology operations incident event classification model is configured to generate a technology operations incident nature classification by processing a technology operations incident event. In some embodiments, a technology operations incident event classification model is configured to generate a technology operations incident nature classification by processing a technology operations incident event using a support vector machine learning model.

As used herein the term “development resource reference unit training vector” refers to a data object that corresponds to development resource reference unit data that is used for training a development resource reference unit assessment model. In some embodiments, a development resource reference unit training vector is indicative of one or more development resource reference unit positive impression values associated with one or more development resource reference units. In some embodiments, a development resource reference unit training vector is indicative of one or more development resource reference unit negative impression values associated with one or more development resource reference units. In some embodiments, a development resource reference unit training vector is indicative of one or more development resource reference unit update timestamps associated with one or more development resource reference units. In some embodiments, a development resource reference unit training vector is indicative of one or more maximum development resource reference unit resolution event metrics associated with one or more development resource reference units. In some embodiments, a development resource reference unit training vector is indicative of one or more development resource reference unit natures associated with one or more development resource reference unit development resource reference units. In some embodiments, a development resource reference unit training vector is indicative of one or more technology operations incident events associated with one or more development resource reference units. In some embodiments, a development resource reference unit training vector is indicative of one or more technology operations incident nature classifications associated with one or more development resource reference units. In some embodiments, a development resource reference unit training vector is stored in a development resource reference unit embedding vector repository.

As used herein, the term “development resource reference unit assessment model” refers to a data entity that describes parameters, hyper-parameters, and/or defined operations of a rules-based and/or machine learning model that is configured to generate a development resource reference unit impact value. In some embodiments, a development resource reference unit assessment model is configured to generate a development resource reference unit impact value using development resource reference unit data. In some embodiments, a development resource reference unit assessment model is configured to be trained using one or more development resource reference unit training vectors.

As used herein the term “candidate development resource reference unit embedding vector” refers to a data object that corresponds to a development resource reference unit that is a candidate for being used to respond to and/or resolve a technology operations incident event associated with a development resource and technology operations server. In some embodiments, a candidate development resource reference unit embedding vector is indicative of a candidate development resource reference unit identifier associated with a development resource reference unit. In some embodiments, a candidate development resource reference unit embedding vector is indicative of a candidate development resource reference unit link associated with a development resource reference unit. In some embodiments, a candidate development resource reference unit embedding vector is indicative of a candidate development resource reference unit nature associated with a development resource reference unit. In some embodiments, a candidate development resource reference unit embedding vector is indicative of a candidate development resource reference unit fragment associated with a development resource reference unit. In some embodiments, a candidate development resource reference unit embedding vector is stored in a development resource reference unit embedding vector repository. In some embodiments, a candidate development resource reference unit embedding vector is indicative of a candidate development resource reference unit impact value.

As used herein the term “candidate development resource reference unit identifier” refers to one or more items of data by which a development resource reference unit that is a candidate for being used to respond to and/or resolve a technology operations incident event is uniquely identified in a development resource and technology operations system, a development resource reference unit repository, a development resource reference unit embedding vector repository, and/or the like. A candidate development resource reference unit identifier may comprise one or more of ASCII text, encryption keys, identification certificates, a pointer, an IP address, a URL, a MAC address, a memory address, or other unique identifier, or combinations thereof.

As used herein the term “candidate development resource reference unit link” refers to a data object that facilitates access to a development resource reference unit that is a candidate for being used to respond to and/or resolve a technology operations incident event associated with a development resource and technology operations server. For example, a candidate development resource reference unit link may facilitate access to a development resource reference unit from a location other than where the development resource reference unit is stored and/or hosted.

As used herein, the term “candidate development resource reference unit nature” refers to one or more items of data that describes a nature, intent, and/or classification of the content of a development resource reference unit that is a candidate for being used to respond to and/or resolve a technology operations incident event associated with a development resource and technology operations server.

As used herein, the term “candidate development resource reference unit fragment” refers to a portion of a development resource reference unit that is a candidate for being used to respond to and/or resolve a technology operations incident event associated with a development resource and technology operations server. In some embodiments, a candidate development resource reference unit fragment includes text that is representative of a portion of a development resource reference unit.

As used herein, the term “candidate development resource reference unit impact value” refers to one or more items of data that indicates a development resource reference unit impact value of a development resource reference unit that is a candidate for being used to respond to and/or resolve a technology operations incident event associated with a development resource and technology operations server.

As used herein the term “candidate development resource reference unit embedding vector filtering model” refers to a data entity that describes parameters, hyper-parameters, and/or defined operations of a rules-based and/or machine learning model that is configured to filter a plurality of development resource reference unit embedding vectors. In some embodiments, a candidate development resource reference unit embedding vector filtering model is configured to filter a plurality of development resource reference unit embedding vectors based at least in part on a technology operations incident nature classification. In some embodiments, a candidate development resource reference unit embedding vector filtering model is configured to filter a plurality of development resource reference unit embedding vectors to identify a candidate development resource reference unit embedding vector. In this regard, for example, a candidate development resource reference unit embedding vector filtering model may be configured to perform a hierarchical semantic search of a development resource reference unit embedding vector repository to identify a candidate development resource reference unit embedding vector.

As used herein the term “candidate development resource reference unit embedding vector ranking model” refers to a data entity that describes parameters, hyper-parameters, and/or defined operations of a rules-based and/or machine learning model that is configured to rank one or more candidate development resource reference unit embedding vector. In some embodiments, a candidate development resource reference unit embedding vector ranking model is configured to rank one or more candidate development resource reference unit embedding vectors that have been identified by a candidate development resource reference unit embedding vector filtering model. In some embodiments, a candidate development resource reference unit embedding vector ranking model is configured to rank one or more candidate development resource reference unit embedding vectors based on each of the one or more candidate development resource reference unit embedding vectors suitability for responding to and/or resolving a technology operations incident event. For example, a candidate development resource reference unit embedding vector ranking model may be configured to rank one or more candidate development resource reference unit embedding vectors based on a candidate development resource reference unit impact value associated with each of the one or more candidate development resource reference unit embedding vectors.

As used herein the term “candidate development resource reference unit structure” refers to a data structure that includes a candidate development resource reference unit fragment and/or a candidate development resource reference unit link. In some embodiments, a candidate development resource reference unit structure is configured to be displayed on a technology operations incident event response interface component. In some embodiments, a candidate development resource reference unit structure is generate based at least in part on a candidate development resource reference unit embedding vector and/or a retrieval operation. In some embodiments, a candidate development resource reference unit structure is stored in a development resource and technology operations repository.

As used herein the term “retrieval operation” refers to a data object that provides retrieval commands, retrieval techniques, retrieval directives, and/or retrieval specifications for generating a candidate development resource reference unit structure based at least in part on a candidate development resource reference unit embedding vector. In this regard, for example, a retrieval operation may be configured to provide retrieval commands, retrieval techniques, retrieval directives, and/or retrieval specifications for retrieving a candidate development resource reference unit fragment and/or a candidate development resource reference unit link from a candidate development resource reference unit embedding vector.

As used herein the term “candidate technology operations incident responsive direction” refers to one or more items of data that describes a curated summary of a candidate development resource reference unit and/or a recommendation for responding to and/or resolving a technology operations incident event based at least in part on a candidate development resource reference unit. In some embodiments, a candidate technology operations incident responsive direction is configured to be displayed on a technology operations incident event response interface component. In some embodiments, a candidate technology operations incident responsive direction is stored in a development resource and technology operations repository.

As used herein the term “technology operations incident responsive direction generation model” refers to a data entity that describes parameters, hyper-parameters, and/or defined operations of a rules-based and/or machine learning model that is configured to generate a candidate technology operations incident responsive direction. In some embodiments, a technology operations incident responsive direction generation model may be configured to generate a candidate technology operations incident responsive direction by processing a candidate development resource reference unit fragment. In some embodiments, processing a candidate technology operations incident responsive direction includes the technology operations incident responsive direction generation model being configured to perform one or more retrieval augment generation operations.

As used herein the term “retrieval augment generation operation” refers to a data object that provides retrieval augment generation commands, retrieval augment generation techniques, retrieval augment generation directives, and/or retrieval augment generation specifications for generating a candidate technology operations incident responsive direction.

As used herein the term “reinforcement learning operation” refers to a data object that provides reinforcement learning commands, reinforcement learning techniques, reinforcement learning, and/or reinforcement learning specifications for training a candidate development resource reference unit embedding vector ranking model and/or a development resource reference unit impact value. In this regard, for example, a reinforcement learning operation may use feedback received from a development resource and technology operations system and/or a user associated with a development resource and technology operations system to train a candidate development resource reference unit embedding vector ranking model and/or a development resource reference unit impact value.

As used herein, the term “technology operations incident event response interface” refers to a graphical user interface of a development resource and technology operations system that is configured to enable one or more users to view and engage with one or more development resource and technology operations system workspaces, views, and/or interface components. In some embodiments, for example, a technology operations incident event response interface is configured to enable one or more users to view and engage with one or more technology operations incident event response interface components. In some embodiments, a technology operations incident event response interface may be rendered to a client device based on data provided by development resource and technology operations server. In some embodiments, such data and instructions are facilitated by a dedicated software application running on the client device. In other embodiments, such data and instructions are provided through a web browser running on the client device.

As used herein, the term “technology operations incident event response interface component” refers to a graphical user interface element that is rendered to, or as a portion of, a technology operations incident event response interface of a development resource and technology operations system. In some embodiments, a technology operations incident event response interface component is configured to display a candidate development resource reference unit structure and/or a candidate technology operations incident responsive direction.

The terms “data,” “content,” “digital content,” “digital content object,” “signal,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be transmitted directly to another computing device or may be transmitted indirectly via one or more intermediary computing devices, such as, for example, one or more servers, relays, routers, network access points, base stations, hosts, and/or the like.

As used herein, the term “computer-readable storage medium” refers to a non-transitory, physical, or tangible storage medium (e.g., volatile or non-volatile memory), which may be differentiated from a “computer-readable transmission medium,” which refers to an electromagnetic signal. Such a medium can take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization, or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums can be substituted for or used in addition to the computer-readable storage medium in alternative embodiments.

The terms “client device,” “computing device,” “network device,” “computer,” “user equipment,” and similar terms may be used interchangeably to refer to computer hardware and/or software that is configured to access a service made available by a server (e.g., development resource and technology operations server). The server is often (but not always) on another computer system, in which case the client device accesses the service by way of a network. Client devices may include, without limitation, smart phones, tablet computers, laptop computers, wearables, personal computers, enterprise computers, and the like.

As used herein, the term “circuitry” refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of “circuitry” applies to all uses of this term herein, including in any claims. As a further example, the term “circuitry” also includes an implementation comprising one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device, and/or other computing device.

As used herein, the terms “application,” “software application,” “app,” “product,” “service” or similar terms refer to a computer program or group of computer programs designed to perform coordinated functions, tasks, or activities for the benefit of a user or group of users. A software application can run on a server or group of servers (e.g., a physical or virtual servers in a cloud-based computing environment). In certain embodiments, an application is designed for use by and interaction with one or more local, networked, or remote computing devices, such as, but not limited to, client devices. Non-limiting examples of an application comprise project management, workflow engines, software incident management, team collaboration suites, cloud services, word processors, spreadsheets, accounting applications, web browsers, email clients, media players, file viewers, videogames, audio-video conferencing, and photo/video editors. In some embodiments, an application is a cloud product.

The terms “database,” “repository,” and/or similar terms used herein interchangeable may refer to a collection of records or data that is stored in a computer-readable storage medium using one or more database types. The term “database type” may refer to a type of database, such as a hierarchical database, network database, relational database (e.g., Aurora, RDS), entity-relationship database, object database (e.g., S3), document database, semantic database, graph database, noSqL database (e.g., DynamoDB), and/or the like.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment.

As used herein, the terms “illustrative,” “example,” “exemplary” and the like are used to mean “serving as an example, instance, or illustration” with no indication of quality level. Any implementation described herein as “exemplary” or “example” is not necessarily to be construed as preferred or advantageous over other implementations.

The terms “about,” “approximately,” “generally,” “substantially,” or the like, when used with a number, may mean that specific number, or alternatively, a range in proximity to the specific number, as understood by persons of skill in the art field and may be used to refer to within manufacturing and/or engineering design tolerances for the corresponding materials and/or elements as would be understood by the person of ordinary skill in the art, unless otherwise indicated.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

If the specification presents a list, unless stated otherwise, it is to be understood that each individual element of that list, and every combination of components of that list, is a separate embodiment. For example, “1, 2, 3, 4, and 5” encompasses, among numerous embodiments, 1; 2; 3; 1 and 2; 3 and 5; 1, 3, and 5; and 1, 2, 4, and 5.

The term “plurality” refers to two or more items.

The term “set” refers to a collection of one or more items.

The term “or” is used herein in both the alternative and conjunctive sense, unless otherwise indicated.

### EXAMPLE SYSTEMS AND APPARATUSES OF THE DISCLOSURE

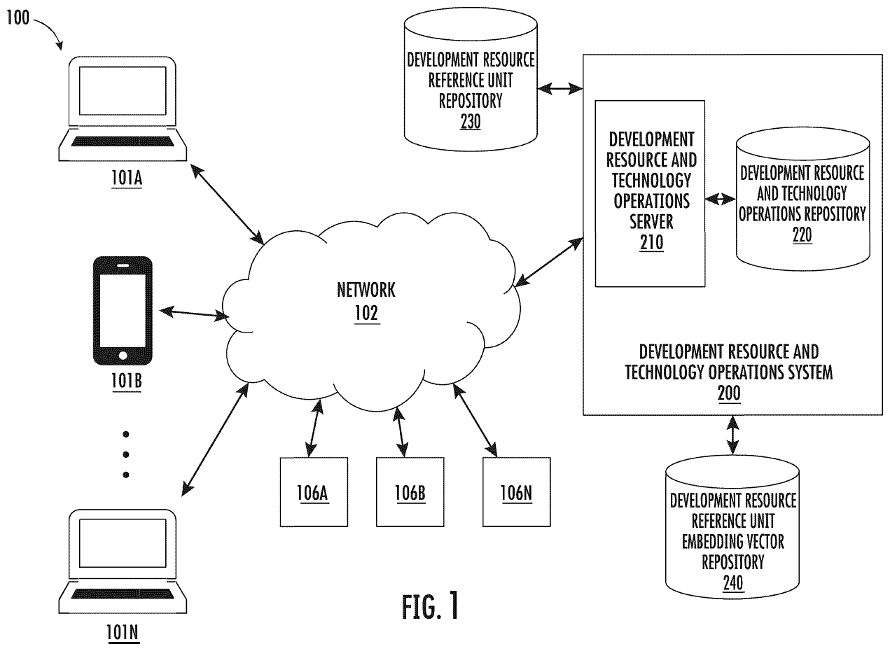

Referring now to FIG. 1, an example computing system 100 architecture within which some embodiments of the present disclosure operate is illustrated. The example computing system 100 comprises one or more software development tools 106A-106N, development resource and technology operations system 200, and a plurality of client devices 101A-101N, each communicatively connected through a communications network 102. Accordingly, user(s) (e.g., team member, individual contributor, team leader, team member, designer, etc.) may access the development resource and technology operations system 200 via the communications network 102 using one or more of client devices 101A-101N. Development resource and technology operations system 200 may comprise an development resource and technology operations server 210 in communication with at least one repository, such as a development resource and technology operations repository 220, a development resource reference unit embedding vector repository 240, and/or an development resource reference unit repository 230. Such repository (ies) may be hosted by the development resource and technology operations server 210 or otherwise hosted by devices in communication with the development resource and technology operations server 210.

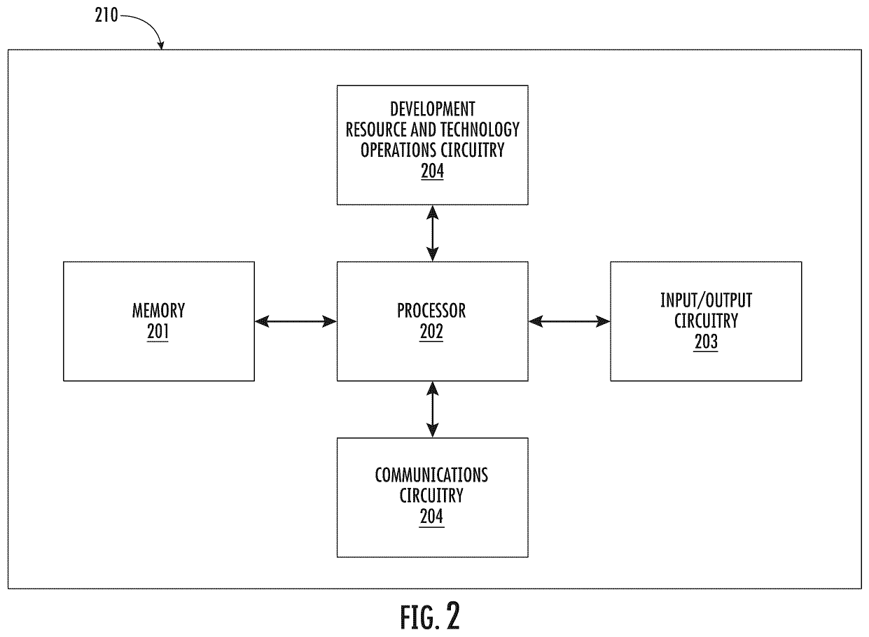

Development resource and technology operations server 210 may include circuitry, networked processors, or the like configured to perform some or all of the development resource and technology operations server-based processes described herein and may be any suitable network server and/or other type of processing device. In some embodiments, development resource and technology operations server 210 may determine and transmit commands and instructions for rendering one or more resource operational interfaces to client devices 101A-101N, using data from, for example, the development resource and technology operations repository 220, the development resource reference unit embedding vector repository 240, and/or the development resource reference unit repository 230. In this regard, the development resource and technology operations server 210 may be embodied by any of a variety of devices, for example, the development resource and technology operations server 210 may be embodied as a computer or a plurality of computers. For example, development resource and technology operations server 210 may be configured to receive/transmit data and may include any of a variety of fixed terminals, such as a server, desktop, or kiosk, or it may comprise any of a variety of mobile terminals, such as a portable digital assistant (PDA), mobile telephone, smartphone, laptop computer, tablet computer, or in some embodiments, a peripheral device that connects to one or more fixed or mobile terminals. Example embodiments contemplated herein may have various form factors and designs but will nevertheless include at least the components illustrated in FIG. 2 and described in connection therewith. In some embodiments, development resource and technology operations server 210 may be located remotely from the development resource and technology operations repository 220, the development resource reference unit embedding vector repository 240, and/or the development resource reference unit repository 230, although in other embodiments, the development resource and technology operations server 210 may comprise the development resource and technology operations repository 220, the development resource reference unit embedding vector repository 240, and/or the development resource reference unit repository 230. The development resource and technology operations server 210 may, in some embodiments, comprise several servers or computing devices performing interconnected and/or distributed functions. Despite the many arrangements contemplated herein, development resource and technology operations server 210 is shown and described herein as a single computing device to avoid unnecessarily overcomplicating the disclosure.

Development resource and technology operations server 210 can communicate with one or more client devices 101A-101N via communications network 102. Communications network 102 may include any one or more wired and/or wireless communication networks including, for example, a wired or wireless local area network (LAN), personal area network (PAN), metropolitan area network (MAN), wide area network (WAN), or the like, as well as any hardware, software and/or firmware required for implementing the one or more networks (e.g., network routers, switches, hubs, etc.). For example, communications network 102 may include a cellular telephone, mobile broadband, long term evolution (LTE), GSM/EDGE, UMTS/HSPA, IEEE 702.11, IEEE 702.16, IEEE 702.20, Wi-Fi, dial-up, and/or WiMAX network. Furthermore, the communications network 102 may include a public network, such as the Internet, a private network, such as an intranet, or combinations thereof, and may utilize a variety of networking protocols now available or later developed including, but not limited to TCP/IP based networking protocols. For instance, the networking protocol may be customized to suit the needs of the development resource and technology operations system 200.

The development resource and technology operations repository 220 may be stored by any suitable storage device configured to store some or all of the information described herein (e.g., memory 201 of the development resource and technology operations server 210 or a separate memory system separate from the development resource and technology operations server 210, such as one or more database systems, backend data servers, network databases, cloud storage devices, or the like provided by another device (e.g., online application or 3^{rd} party provider), such as a Network Attached Storage (NAS) device or devices, or as a separate database server or servers. The development resource and technology operations repository 220 may comprise data received from the development resource and technology operations server 210 (e.g., via a memory 201 and/or processor(s) 202), and the corresponding storage device may thus store this data. The development resource and technology operations repository 220 includes information accessed and stored by the development resource and technology operations server 210 to facilitate the operations of the development resource and technology operations system 200.

The development resource reference unit embedding vector repository 240 may be stored by any suitable storage device configured to store some or all of the information described herein (e.g., memory 201 of the development resource and technology operations server 210 or a separate memory system separate from the development resource and technology operations server 210, such as one or more database systems, backend data servers, network databases, cloud storage devices, or the like provided by another device (e.g., online application or 3^{rd} party provider), such as a Network Attached Storage (NAS) device or devices, or as a separate database server or servers. The development resource reference unit embedding vector repository 240 may comprise data received from the development resource and technology operations server 210 (e.g., via a memory 201 and/or processor(s) 202), and the corresponding storage device may thus store this data. The development resource reference unit embedding vector repository 240 includes information accessed and stored by the development resource and technology operations server 210 to facilitate the operations of the development resource and technology operations system 200.

The development resource reference unit repository 230 may be stored by any suitable storage device configured to store some or all of the information described herein (e.g., memory 201 of the development resource and technology operations server 210 or a separate memory system separate from the development resource and technology operations server 210, such as one or more database systems, backend data servers, network databases, cloud storage devices, or the like provided by another device (e.g., online application or 3^{rd} party provider), such as a Network Attached Storage (NAS) device or devices, or as a separate database server or servers. The development resource reference unit repository 230 may comprise data received from the development resource and technology operations server 210 (e.g., via a memory 201 and/or processor(s) 202), and the corresponding storage device may thus store this data. The development resource reference unit repository 230 includes information accessed and stored by the development resource and technology operations server 210 to facilitate the operations of the development resource and technology operations system 200.

Software development tools 106A-106N may be any one or more underlying software development tools (e.g., Bitbucket®, etc.).

The client devices 101A-10 IN may be implemented as any computing device as defined above. Electronic data received by the development resource and technology operations server 210 from the client devices 101A-101N may be provided in various forms and via various methods. For example, the client devices 101A-101N may include desktop computers, laptop computers, smartphones, netbooks, tablet computers, wearables, and/or other networked device, that may be used for any suitable purpose in addition to presenting the development resource reference unit interface and/or the technology operations incident event response interface to a user and otherwise providing access to the development resource and technology operations system 200. The depiction in FIG. 2 of “N” client devices is merely for illustration purposes. According to some embodiments, the client devices 101A-101N may be configured to display an interface on a display of the client device for viewing, creating, editing, and/or otherwise interacting with at least the development resource reference unit interface and/or the technology operations incident event response interface, which may be provided by the development resource and technology operations system 200. According to further embodiments, the client devices 101A-101N may be configured to generate and/or display a development resource reference unit interface component, a development resource reference unit impact interface component, a technology operations incident event response interface component, and/or the like.

In embodiments where a client device 101A-101N is a mobile device, such as a smartphone or tablet, the client device 101A-101N may execute an “app” to interact with the development resource and technology operations system 200. Such apps are typically designed to execute on mobile devices, such as tablets or smartphones. For example, an app may be provided that executes on mobile device operating systems such as iOS®, Android™, or Windows®. These platforms typically provide frameworks that allow apps to communicate with one another and with particular hardware and software components of mobile devices. The mobile operating systems named above each provide frameworks for interacting with, for example, wired and wireless network interfaces, user contacts, and other applications. Communication with hardware and software modules executing outside of the app is typically provided via application programming interfaces (APIs) provided by the mobile device operating system. Additionally, or alternatively, the client device 101A-101N may interact with the development resource and technology operations system 200 via a web browser. As yet another example, the client devices 101A-101N may include various hardware or firmware designed to interface with the development resource and technology operations system 200.

### Example Apparatus for Implementing Embodiments of the Present Disclosure

FIG. 2 illustrates an example development resource and technology operations server 210 in accordance with at least some example embodiments of the present disclosure. In accordance with some example embodiments, development resource and technology operations server 210 may include various components, modules, circuitries, or means, some or all of which may be also or instead be included in one or more client device(s) 101A-101N. In accordance with some example embodiments, development resource and technology operations server 210 may be configured, using one or more of the sets of circuitry embodying memory 201, processor 202, input/output circuitry 203, communications circuitry 204, and/or development resource and technology operations circuitry 205 to execute and perform the operations described herein. In some embodiments, development resource and technology operations circuitry 205 is included in development resource and technology operations server 210 and/or client device 101A, the circuitry configured to facilitate the functionality discussed herein. It will be appreciated that while various references are made herein to a “server” or “servers” such references are not intended to implicate monolithic servers. Rather, as will be apparent to one of ordinary skill in the art in view of this disclosure, the operations and functionality attributed to any disclosed server may be performed in a cloud computing environment and thereby completed by multiple servers.

Although the use of the term “circuitry” as used herein with respect to components 201- 205 are described in some cases with respect to functional limitations, it should be understood that the particular implementations necessarily include the use of particular hardware configured to perform the functions associated with the respective circuitry as described herein. It should also be understood that certain of these components 201-205 may include similar or common hardware. For example, two sets of circuitry may both leverage use of the same processor(s), network interface(s), storage medium(s), and/or the like, to perform their associated functions, such that duplicate hardware is not required for each set of circuitry. The use of the term “circuitry” with respect to components of the apparatuses described herein should therefore be understood to include particular hardware configured to perform the functions associated with the respective components or particular circuitry as described herein.

The term “circuitry” should also be understood, in some embodiments, to include software for configuring the hardware. For example, in some embodiments, “circuitry” may include processing circuitry, storage media, network interfaces, input/output devices, and the like. In some embodiments, such as in examples where circuitry is included with development resource and technology operations server 210, other elements of the development resource and technology operations server 210 may provide or supplement the functionality of particular circuitry. For example, the processor 202 may provide processing functionality, the memory 201 may provide storage functionality, the communications circuitry 204 may provide network interface functionality, and the like.

In some embodiments, the processor 202 (and/or co-processor or any other processing circuitry assisting or otherwise associated with the processor) may be in communication with the memory 201 via a bus for passing information among components of, for example, development resource and technology operations server 210. The memory 201 is non-transitory and may include, for example, one or more volatile and/or non-volatile memories, or some combination thereof. In other words, for example, the memory 201 may be an electronic storage device (e.g., a computer readable storage medium). The memory 201 may be configured to store information, data, content, applications, instructions, or the like, for enabling an apparatus, e.g., development resource and technology operations server 210 to carry out various functions in accordance with example embodiments of the present disclosure.

Although illustrated in FIG. 2 as a single memory, memory 201 may comprise a plurality of memory components. The plurality of memory components may be embodied on a single computing device or distributed across a plurality of computing devices. In various embodiments, memory 201 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 201 may be configured to store information, data, applications, instructions, or the like for enabling development resource and technology operations server 210 to carry out various functions in accordance with example embodiments discussed herein. For example, in at least some embodiments, memory 201 is configured to buffer data for processing by processor 202. Additionally, or alternatively, in at least some embodiments, memory 201 is configured to store program instructions for execution by processor 202. Memory 201 may store information in the form of static and/or dynamic information. This stored information may be stored and/or used by development resource and technology operations server 210 during the course of performing its functionalities.

Processor 202 may be embodied in a number of different ways and may, for example, include one or more processing devices configured to perform independently. Additionally, or alternatively, processor 202 may include one or more processors configured in tandem via a bus to enable independent execution of instructions, pipelining, and/or multithreading. Processor 202 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. The use of the term “processing circuitry” may be understood to include a single core processor, a multi-core processor, multiple processors internal to the apparatus, and/or remote or “cloud” processors. Accordingly, although illustrated in FIG. 2 as a single processor, in some embodiments, processor 202 comprises a plurality of processors. The plurality of processors may be embodied on a single computing device or may be distributed across a plurality of such devices collectively configured to function as development resource and technology operations server 210. The plurality of processors may be in operative communication with each other and may be collectively configured to perform one or more functionalities of development resource and technology operations server 210 as described herein.

In an example embodiment, processor 202 is configured to execute instructions stored in the memory 201 or otherwise accessible to processor 202. Alternatively, or additionally, the processor 202 may be configured to execute hard-coded functionality. As such, whether configured by hardware or software methods, or by a combination thereof, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure processor 202 to perform one or more algorithms and/or operations described herein when the instructions are executed. For example, these instructions, when executed by processor 202, may cause development resource and technology operations server 210 to perform one or more of the functionalities of development resource and technology operations server 210 as described herein.

In some embodiments, input/output circuitry 203 may, in turn, be in communication with processor 202 to provide an audible, visual, mechanical, or other output and/or, in some embodiments, to receive an indication of an input. In that sense, input/output circuitry 203 may include means for performing analog-to-digital and/or digital-to-analog data conversions. Input/output circuitry 203 may include support, for example, for a display, touchscreen, keyboard, button, click wheel, mouse, joystick, an image capturing device (e.g., a camera), motion sensor (e.g., accelerometer and/or gyroscope), microphone, audio recorder, speaker, biometric scanner, and/or other input/output mechanisms. Input/output circuitry 203 may comprise a user interface (e.g., resource operational interface) and may comprise a web user interface, a mobile application, a kiosk, or the like. The processor 202 and/or user interface circuitry comprising the processor 202 may be configured to control one or more functions of a display or one or more user interface elements through computer program instructions (e.g., software and/or firmware) stored on a memory accessible to the processor 202 (e.g., memory 201, and/or the like). In some embodiments, aspects of input/output circuitry 203 in development resource and technology operations server 210 may be reduced when implemented also or instead as an end-user machine or other type of device designed for complex user interactions (i.e., client device 101). In some embodiments (like other components discussed herein), input/output circuitry 203 may even be eliminated from development resource and technology operations server 210. Alternatively, at least some aspects of input/output circuitry 203 may be embodied on an apparatus used by a user (e.g., a team member, an individual contributor, a team leader, and/or the like) that is in communication with development resource and technology operations server 210. Input/output circuitry 203 may be in communication with memory 201, communications circuitry 204, and/or any other component(s), such as via a bus. Although more than one input/output circuitry and/or other component can be included in development resource and technology operations server 210, only one is shown in FIG. 2 to avoid overcomplicating the disclosure (e.g., like the other components discussed herein).

Communications circuitry 204 may be any means such as a device or circuitry embodied in either hardware or a combination of hardware and software that is configured to receive and/or transmit data from/to a network and/or any other device, circuitry, or module in communication with development resource and technology operations server 210. In this regard, the communications circuitry 204 may include, for example, a network interface for enabling communications with a wired or wireless communication network. Communications circuitry 204 may be configured to receive and/or transmit any data that may be stored by memory 201 using any protocol that may be used for communications between computing devices. For example, the communications circuitry 204 may include one or more network interface cards, antennae, transmitters, receivers, buses, switches, routers, modems, and supporting hardware and/or software, and/or firmware/software, or any other device suitable for enabling communications via a network. Additionally, or alternatively, the communication interface may include the circuitry for interacting with the antenna(s) to cause transmission of signals via the antenna(s) or to handle receipt of signals received via the antenna(s). These signals may be transmitted by development resource and technology operations server 210 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols. Communications circuitry 204 may additionally or alternatively be in communication with the memory 201, input/output circuitry 203 and/or any other component of development resource and technology operations server 210, such as via a bus.

In some embodiments, development resource and technology operations circuitry 205 may also or instead be included and configured to perform the functionality discussed herein related to providing a technology operations incident event response interface, a development resource reference unit interface, a development resource reference unit interface component, a development resource reference unit impact interface component, a technology operations incident event response interface component, and/or the like. Development resource and technology operations circuitry 205 includes hardware components and/or software configured to support interface component functionality, features, and/or services of the development resource and technology operations server 210. In some embodiments, development resource and technology operations circuitry 205 includes hardware components and/or software configured to a nature extraction model, a fragment extraction model, a technology operations incident event preprocessing model, a technology operations incident event classification model, a candidate development resource reference unit embedding vector filtering model, a candidate development resource reference unit embedding vector ranking model, a technology operations incident responsive direction generation model, and/or the like of the development resource and technology operations server 210. The development resource and technology operations circuitry 205 may utilize processing circuitry, such as the processor 202, to perform its corresponding operations, and may utilize memory 201 to store collected information.

The development resource and technology operations circuitry 205 may send and/or receive data from development resource and technology operations repository 220, the development resource reference unit embedding vector repository 240, and/or the development resource reference unit repository 230. In some implementations, the sent and/or received data may include development resource reference unit data and/or the like.

It should also be appreciated that, in some embodiments, the development resource and technology operations circuitry 205 may include a separate processor, specially configured field programmable gate array (FPGA), or application specific interface circuit (ASIC) to perform its corresponding functions. For example, in some embodiments, some or all of the functionality of development resource and technology operations circuitry 205 may be performed by processor 202. In this regard, some or all of the example processes and algorithms discussed herein can be performed by at least one processor 202 and/or development resource and technology operations circuitry 205. For example, non-transitory computer readable storage media can be configured to store firmware, one or more application programs, and/or other software, which include instructions and other computer-readable program code portions that can be executed to control processors of the components of development resource and technology operations server 210 to implement various operations, including the examples shown herein. As such, a series of computer-readable program code portions may be embodied in one or more computer program products and can be used, with a device, development resource and technology operations server 210, database, and/or other programmable apparatus, to produce the machine-implemented processes discussed herein. It is also noted that all or some of the information discussed herein can be based on data that is received, generated and/or maintained by one or more components of the development resource and technology operations server 210. In some embodiments, one or more external systems (such as a remote cloud computing and/or data storage system) may also be leveraged to provide at least some of the functionality discussed herein.

As described above and as will be appreciated based on this disclosure, embodiments of the present disclosure may be configured as systems, methods, apparatuses, computing devices, personal computers, servers, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions embodied in the computer-readable storage medium (e.g., computer software stored on a hardware device). Any suitable computer-readable storage medium may be utilized including non-transitory hard disks, CD-ROMs, flash memory, optical storage devices, or magnetic storage devices.

As will be appreciated, any such computer program instructions and/or other type of code may be loaded onto a computer, processor, or other programmable apparatus's circuitry to produce a machine, such that the computer, processor, or other programmable circuitry that execute the code on the machine creates the means for implementing various functions, including those described herein in connection with the components of development resource and technology operations server 210.

The computing systems described herein can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a planning user interacting with the client device). Information/data generated at the client device (e.g., a result of the user interaction) can be received from the client device at the server.

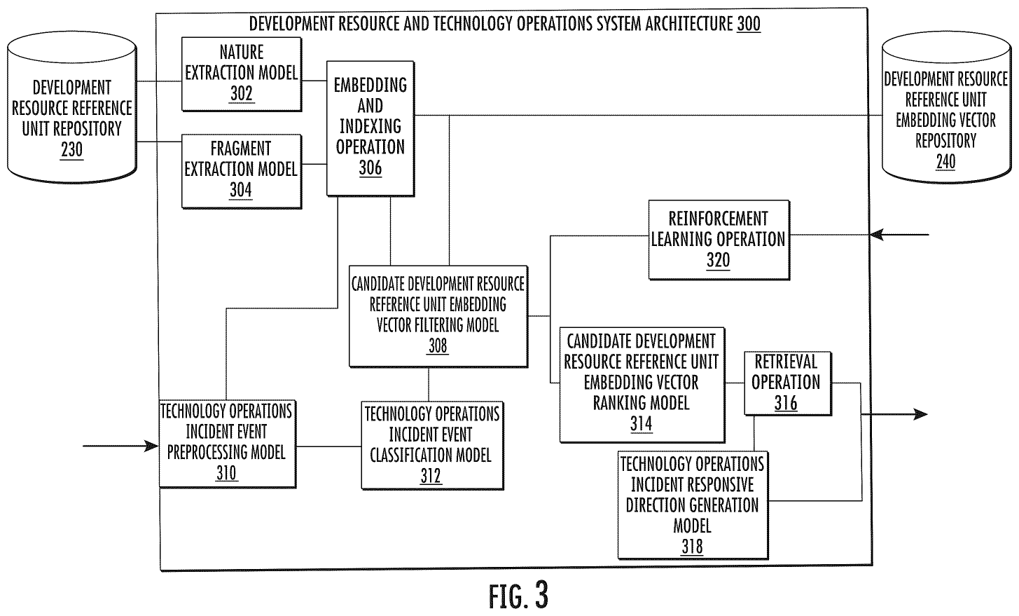

FIG. 3 illustrates a development resource and technology operations system architecture 300 associated with the development resource and technology operations system 200. In this regard, for example, the development resource and technology operations system architecture 300 illustrates an example architecture of the development resource and technology operations system 200. In some embodiments, the one or more components of the development resource and technology operations system architecture 300 are located remotely from the development resource and technology operations system 200. Additionally, or alternatively, one or more component of the development resource and technology operations system architecture 300 are located within the development resource and technology operations system 200 (e.g., the development resource and technology operations system 200 comprises one or more components of the development resource and technology operations system architecture 300).

In some embodiments, the development resource and technology operations system architecture 300 includes a nature extraction model 302. In some embodiments, the nature extraction model 302 is configured to generate a development resource reference unit nature. In some embodiments, the development resource and technology operations system architecture 300 includes a fragment extraction model 304. In some embodiments, the fragment extraction model 304 is configured to generate a development resource reference unit fragment. In some embodiments, the development resource and technology operations system architecture 300 includes embedding and indexing operation 306.

In some embodiments, the development resource and technology operations system architecture 300 includes a technology operations incident event preprocessing model 310. In some embodiments, the technology operations incident event preprocessing model 310 is configured to perform preprocessing on a technology operations incident event. In some embodiments, the development resource and technology operations system architecture 300 includes a technology operations incident event classification model 312. In some embodiments, the technology operations incident event classification model 312 is configured to generate a technology operations incident nature classification. In some embodiments, the development resource and technology operations system architecture 300 includes a candidate development resource reference unit embedding vector filtering model 308. In some embodiments, the candidate development resource reference unit embedding vector filtering model 308 is configured to filter a plurality of development resource reference unit embedding vectors.

In some embodiments, the development resource and technology operations system architecture 300 includes a candidate development resource reference unit embedding vector ranking model 314. In some embodiments, the candidate development resource reference unit embedding vector ranking model 314 is configured to rank one or more candidate development resource reference unit embedding vectors. In some embodiments, the development resource and technology operations system architecture 300 includes a retrieval operation 316. In some embodiments, the retrieval operation 316 is configured to generate a candidate development resource reference unit structure. In some embodiments, the development resource and technology operations system architecture 300 includes a technology operations incident responsive direction generation model 318. In some embodiments, the technology operations incident responsive direction generation model 318 is configured to generate a candidate technology operations incident responsive direction. In some embodiments, the development resource and technology operations system architecture 300 includes a reinforcement learning operation 320. In some embodiments, the reinforcement learning operation 320 is configured to train a candidate development resource reference unit embedding vector ranking model and/or a development resource reference unit impact value.

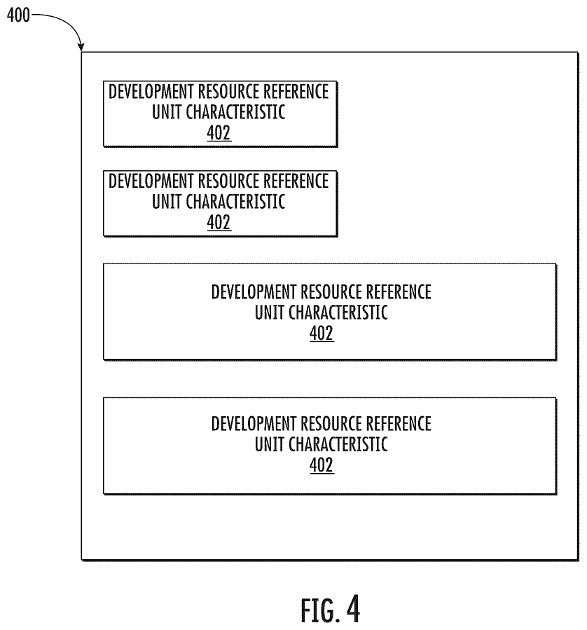

In various embodiments of the present disclosure, an apparatus (e.g., the development resource and technology operations server 210) may be configured to generate, output, manage, and/or cause rendering of a visualization of a development resource reference unit. FIG. 4 illustrates an example visualization of a development resource reference unit 400. In some embodiments, the development resource reference unit 400 in the visualization is a unit of information used for performing one or more functions, actions, operations, and/or the like. For example, the development resource reference unit may be used for responding to and/or resolving a technology operations incident event associated with a development resource and technology operations server 210.

In some embodiments, the development resource reference unit 400 in the visualization is associated with a development resource reference unit characteristic set. For example, as illustrated in FIG. 4, the development resource reference unit 400 in the visualization is associated with a development resource reference unit characteristic set 402. In some embodiments, the development resource reference unit characteristic set 402 is one or more items of data representative of and/or associated with characteristics of the development resource reference unit 400. In some embodiments, the development resource reference unit characteristic set 402 includes a development resource reference unit positive impression value. In some embodiments, the development resource reference unit characteristic set 402 includes a development resource reference unit negative impression value. In some embodiments, the development resource reference unit characteristic set 402 includes a development resource reference unit update timestamp. In some embodiments, the development resource reference unit characteristic set 402 includes a development resource reference unit resolution event metric. In some embodiments, the development resource reference unit characteristic set 402 includes a development resource reference unit identifier. In some embodiments, the development resource reference unit characteristic set 402 includes a development resource reference unit link. In some embodiments, the development resource reference unit characteristic set 402 includes a maximum development resource reference unit resolution event metric. In some embodiments, the development resource reference unit characteristic set 402 includes a development resource reference unit nature.

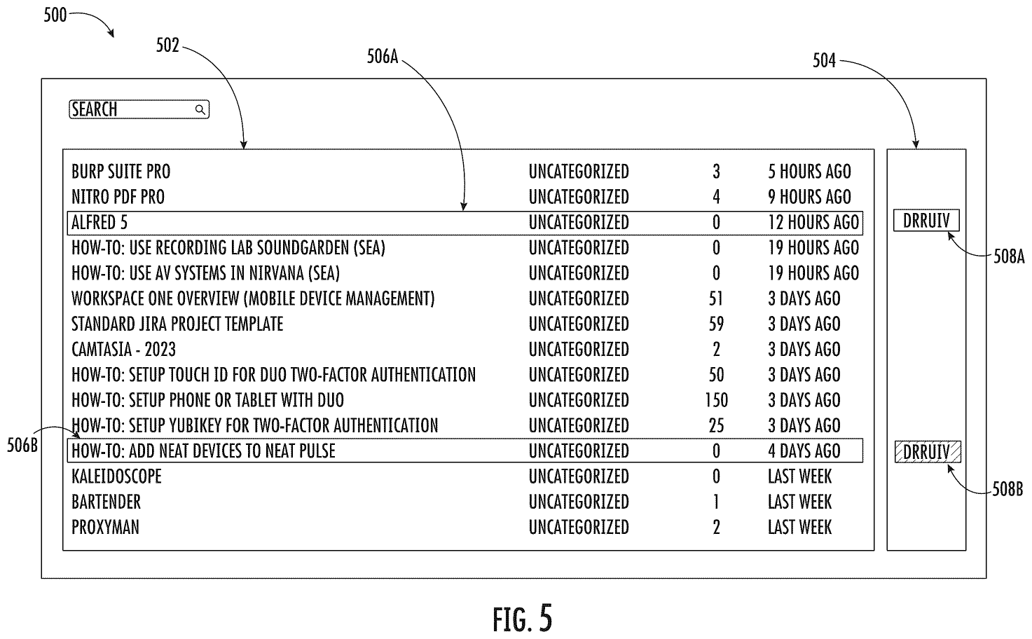

In various embodiments of the present disclosure, an apparatus (e.g., the development resource and technology operations server 210) may be configured to generate, output, manage, and/or cause rendering of a development resource reference unit interface component of a development resource and technology operations system 200. For example, an apparatus (e.g., the development resource and technology operations server 210) may be configured to output and/or cause rendering of a development resource reference unit interface component on a development resource reference unit interface 500 of the development resource and technology operations system 200. FIG. 5 illustrates an example development resource reference unit interface component 502 structured in accordance with various embodiments of the present disclosure. In some embodiments, the apparatus (e.g., development resource and technology operations server 210) causes rendering of the development resource reference unit interface component 502 to a visual display of a computing device (e.g., a client device 101A-101N).

In some embodiments, the development resource reference unit interface component 502 may be configured to display development resource reference unit data. For example, the development resource reference unit interface component 502 may be configured to display first development resource reference unit data 506A and/or second development resource reference unit data 506B. In some embodiments, the first development resource reference unit data 506A and/or second development resource reference unit data 506B may each correspond to a development resource reference unit.

In various embodiments of the present disclosure, an apparatus (e.g., the development resource and technology operations server 210) may be configured to generate, output, manage, and/or cause rendering of a development resource reference unit impact interface component of a development resource and technology operations system 200. For example, an apparatus (e.g., the development resource and technology operations server 210) may be configured to output and/or cause rendering of a development resource reference unit impact interface component on a development resource reference unit interface 500 of the development resource and technology operations system 200. FIG. 5 illustrates an example development resource reference unit impact interface component 504 structured in accordance with various embodiments of the present disclosure. In some embodiments, the apparatus (e.g., development resource and technology operations server 210) causes rendering of the development resource reference unit impact interface component 504 to a visual display of a computing device (e.g., a client device 101A-101N). In some embodiments, the apparatus (e.g., development resource and technology operations server 210) causes rendering of the development resource reference unit impact interface component 504 such that it is proximate the development resource reference unit interface component 502.

In some embodiments, the development resource reference unit impact interface component 504 is configured to display one or more development resource reference unit impact values. For example, the development resource reference unit impact interface component 504 may be configured to display a first development resource reference unit impact value 508A and/or a second development resource reference unit impact value 508B. In some embodiments, the first development resource reference unit impact value 508A may correspond to a development resource reference unit associated with the first development resource reference unit data 506A. In some embodiments, the second development resource reference unit impact value 508B may correspond to a development resource reference unit associated with the second development resource reference unit data 506B. In some embodiments, one or more of the development resource reference unit impact values displayed on the development resource reference unit impact interface component 504 is configured to be visually distinguished using text, markings, color, and/or the like in response to a determination that a development resource reference unit impact value is below a development resource reference unit impact value threshold. For example, the second development resource reference unit impact value 508B may be visually distinguished using text, markings, color, and/or the like in response to a determination that the second development resource reference unit impact value 508B is below a development resource reference unit impact value threshold.

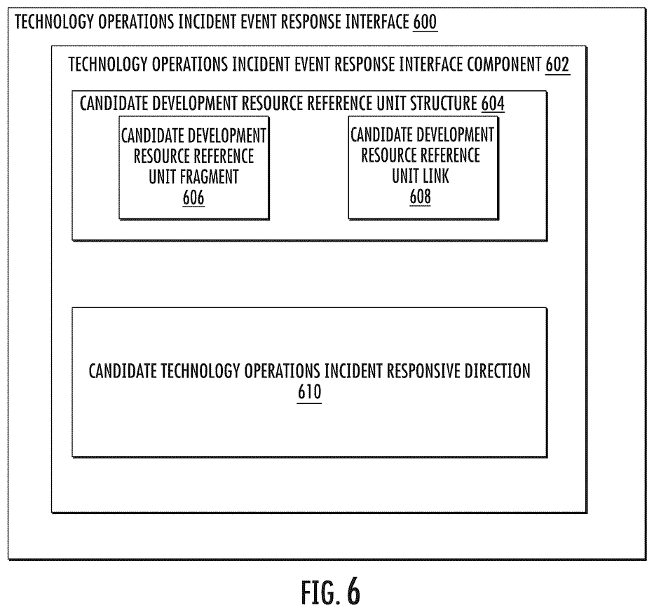

In various embodiments of the present disclosure, an apparatus (e.g., the development resource and technology operations server 210) may be configured to generate, output, manage, and/or cause rendering of a technology operations incident event response interface component of a development resource and technology operations system 200. For example, an apparatus (e.g., the development resource and technology operations server 210) may be configured to output and/or cause rendering of a technology operations incident event response interface component on a technology operations incident event response interface 600 of the development resource and technology operations system 200. FIG. 6 illustrates an example technology operations incident event response interface component 602 structured in accordance with various embodiments of the present disclosure. In some embodiments, the apparatus (e.g., development resource and technology operations server 210) causes rendering of the technology operations incident event response interface component 602 to a visual display of a computing device (e.g., a client device 101A-101N).

In some embodiments, the technology operations incident event response interface component 602 is configured to display one or more candidate development resource reference unit structures. For example, the technology operations incident event response interface component 602 may be configured to display a candidate development resource reference unit structure 604. In some embodiments, the candidate development resource reference unit structure 604 includes a candidate development resource reference unit fragment 606 and/or a candidate development resource reference unit link 608. In some embodiments, the technology operations incident event response interface component 602 is configured to display one or more candidate technology operations incident responsive directions. For example, the technology operations incident event response interface component 602 may be configured to display a candidate technology operations incident responsive direction 610.

### Example Operations Performed

Having described example systems and apparatuses and exemplary circuitry in accordance with various embodiments of the present disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally, or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

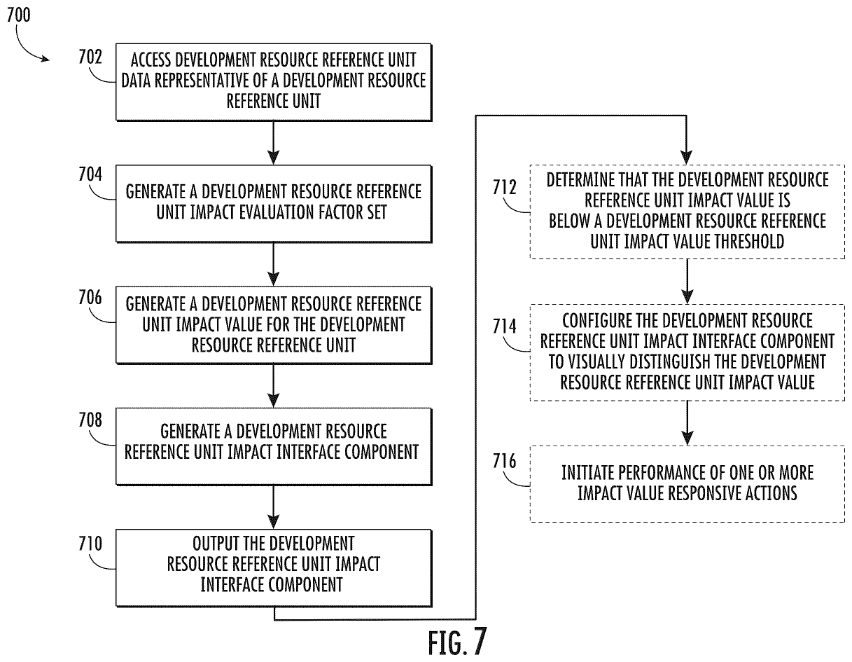

FIG. 7 is a flowchart broadly illustrating a series of operations or process blocks that are executed or performed to output a development resource reference unit impact interface component for rendering to a development resource reference unit interface in accordance with some example embodiments of the present disclosure. In some embodiments, the method 700 is embodied by computer program code stored on a non-transitory computer-readable storage medium of a computer program product configured for execution to perform the process as depicted and described. In this regard, in some such embodiments, the development resource and technology operations server 210 is specially configured by computer-coded instructions (e.g., computer program instructions) stored thereon, for example in the memory 201 and/or another component depicted and/or described herein and/or otherwise accessible to the development resource and technology operations server 210, for performing the operations as depicted and described. Alternatively, or additionally, in some embodiments, the method 700 is performed by one or more specially configured computing devices, such as the development resource and technology operations server 210 alone or in communication with one or more other component(s), device(s), system(s), and/or the like. For example, in some embodiments, the development resource and technology operations server 210 is in communication with one or more external apparatus(es), system(s), device(s), and/or the like, to perform one or more of the operations as depicted and described. For purposes of simplifying the description, the method 700 is described as performed by and from the perspective of the development resource and technology operations server 210. In this regard, performance of the operations may invoke one or more of memory 201, processor 202, input/output circuitry 203, communications circuitry 204, and/or development resource and technology operations circuitry 205.

In the embodiment illustrated in FIG. 7, the flowchart illustrates method 700 which begins at block 702. At block 702, the development resource and technology operations server 210 includes means, such as the memory 201, processor 202, input/output circuitry 203, communications circuitry 204, and/or development resource and technology operations circuitry 205, or a combination thereof, to access development resource reference unit data representative of a development resource reference unit. In some embodiments, development resource reference unit data is one or more items of data representative of and/or associated with a development resource reference unit. Additionally, or alternatively, development resource reference unit data may be one or more items of data representative of and/or associated with a development resource reference unit characteristic set associated with a development resource reference unit. In some embodiments, a development resource reference unit is unit of information used for performing one or more functions, actions, operations, and/or the like. For example, a development resource reference unit may be used for responding to and/or resolving a technology operations incident event associated with a development resource and technology operations server. In some embodiments, a development resource reference unit is associated with a development resource reference unit characteristic set. In some embodiments, a development resource reference unit is stored in a development resource reference unit repository.

At block 704, the development resource and technology operations server 210 includes means, such as the memory 201, processor 202, input/output circuitry 203, communications circuitry 204, and/or development resource and technology operations circuitry 205, or a combination thereof, to generate a development resource reference unit impact evaluation factor set. In some embodiments, a development resource reference unit impact evaluation factor set is one or more items of data representative of and/or associated with characteristics of a development resource reference unit. In some embodiments, a development resource reference unit impact evaluation factor set comprises at least one development resource reference unit evaluation factor. In some embodiments, a development resource reference unit impact evaluation factor set is generated based at least in part on development resource reference unit data.

At block 706, the development resource and technology operations server 210 includes means, such as the memory 201, processor 202, input/output circuitry 203, communications circuitry 204, and/or development resource and technology operations circuitry 205, or a combination thereof, to generate a development resource reference unit impact value. In some embodiments, a development resource reference unit impact value is generated for a development resource reference unit. In some embodiments, a development resource reference unit is impact value is generated based at least on a development resource reference unit impact evaluation factor set.

At block 708, the development resource and technology operations server 210 includes means, such as the memory 201, processor 202, input/output circuitry 203, communications circuitry 204, and/or development resource and technology operations circuitry 205, or a combination thereof, to generate a development resource reference unit impact interface component. In some embodiments, the development resource reference unit impact interface component includes a development resource reference unit impact value.

At block 710, the development resource and technology operations server 210 includes means, such as the memory 201, processor 202, input/output circuitry 203, communications circuitry 204, and/or development resource and technology operations circuitry 205, or a combination thereof, to output the development resource reference unit impact interface component for rendering to a development resource reference unit interface. In some embodiments, a development resource reference unit impact interface component may be rendered to a development resource reference unit interface such that the development resource reference unit impact interface component is proximate a development resource reference unit interface component.

At optional block 712, the development resource and technology operations server 210 includes means, such as the memory 201, processor 202, input/output circuitry 203, communications circuitry 204, and/or development resource and technology operations circuitry 205, or a combination thereof, to determine that the development resource reference unit impact value is below a development resource reference unit impact value threshold. In some embodiments, when the development resource reference unit impact value does not meet the development resource reference unit impact value threshold (e.g., the development resource reference unit impact value is below the development resource reference unit impact value threshold) the development resource and technology operations system may initiate performance of one or more impact value responsive actions.

At optional block 714, the development resource and technology operations server 210 includes means, such as the memory 201, processor 202, input/output circuitry 203, communications circuitry 204, and/or development resource and technology operations circuitry 205, or a combination thereof, to configure the development resource reference unit impact interface component to visually distinguish the development resource reference unit impact value. In some embodiments, the development resource reference unit impact interface component may be configured to visually distinguish the development resource reference unit impact value in response to a determination that the development resource reference unit impact value is below a development resource reference unit impact value threshold.

At optional block 716, the development resource and technology operations server 210 includes means, such as the memory 201, processor 202, input/output circuitry 203, communications circuitry 204, and/or development resource and technology operations circuitry 205, or a combination thereof, to initiate performance of one or more impact value responsive actions. In some embodiments, performance of one or more impact value responsive actions may be initiated based at least in part on the development resource reference unit impact value.

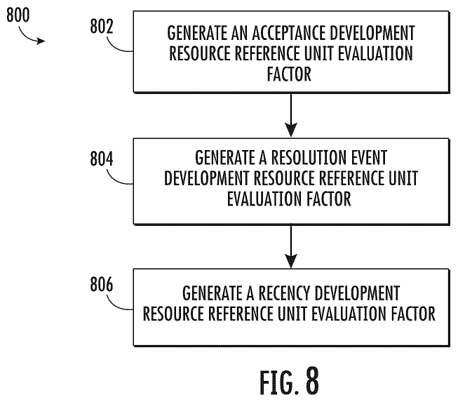

FIG. 8 is a flowchart broadly illustrating a series of operations or process blocks that are executed or performed to generate a development resource reference unit impact evaluation factor set in accordance with some example embodiments of the present disclosure. In some embodiments, the method 800 is embodied by computer program code stored on a non-transitory computer-readable storage medium of a computer program product configured for execution to perform the process as depicted and described. In this regard, in some such embodiments, the development resource and technology operations server 210 is specially configured by computer-coded instructions (e.g., computer program instructions) stored thereon, for example in the memory 201 and/or another component depicted and/or described herein and/or otherwise accessible to the development resource and technology operations server 210, for performing the operations as depicted and described. Alternatively, or additionally, in some embodiments, the method 800 is performed by one or more specially configured computing devices, such as the development resource and technology operations server 210 alone or in communication with one or more other component(s), device(s), system(s), and/or the like. For example, in some embodiments, the development resource and technology operations server 210 is in communication with one or more external apparatus(es), system(s), device(s), and/or the like, to perform one or more of the operations as depicted and described. For purposes of simplifying the description, the method 800 is described as performed by and from the perspective of the development resource and technology operations server 210. In this regard, performance of the operations may invoke one or more of memory 201, processor 202, input/output circuitry 203, communications circuitry 204, and/or development resource and technology operations circuitry 205.

In the embodiment illustrated in FIG. 8, the flowchart illustrates method 800 which begins at block 802. At block 802, the development resource and technology operations server 210 includes means, such as the memory 201, processor 202, input/output circuitry 203, communications circuitry 204, and/or development resource and technology operations circuitry 205, or a combination thereof, to generate an acceptance development resource reference unit evaluation factor. In some embodiments, an acceptance development resource reference unit evaluation factor may be generated by performing an acceptance operation using development resource reference unit data.

At block 804, the development resource and technology operations server 210 includes means, such as the memory 201, processor 202, input/output circuitry 203, communications circuitry 204, and/or development resource and technology operations circuitry 205, or a combination thereof, to generate a resolution event development resource reference unit evaluation factor. In some embodiments, a resolution event development resource reference unit evaluation factor may be generated by performing a resolution event operation using development resource reference unit data.

At block 806, the development resource and technology operations server 210 includes means, such as the memory 201, processor 202, input/output circuitry 203, communications circuitry 204, and/or development resource and technology operations circuitry 205, or a combination thereof, to generate a recency development resource reference unit evaluation factor. In some embodiments, a recency event development resource reference unit evaluation factor may be generated by performing a recency operation using development resource reference unit data.

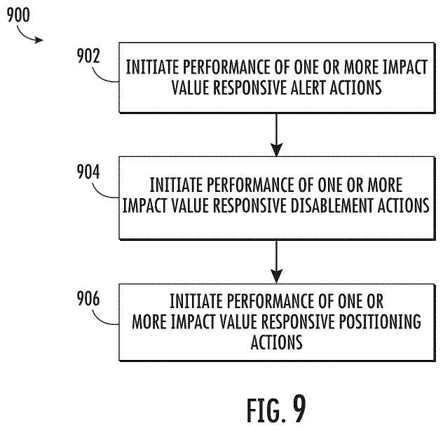

FIG. 9 is a flowchart broadly illustrating a series of operations or process blocks that are executed or performed to initiate performance of one or more impact value responsive actions based at least in part on a development resource reference unit impact value in accordance with some example embodiments of the present disclosure. In some embodiments, the method 900 is embodied by computer program code stored on a non-transitory computer-readable storage medium of a computer program product configured for execution to perform the process as depicted and described. In this regard, in some such embodiments, the development resource and technology operations server 210 is specially configured by computer-coded instructions (e.g., computer program instructions) stored thereon, for example in the memory 201 and/or another component depicted and/or described herein and/or otherwise accessible to the development resource and technology operations server 210, for performing the operations as depicted and described. Alternatively, or additionally, in some embodiments, the method 900 is performed by one or more specially configured computing devices, such as the development resource and technology operations server 210 alone or in communication with one or more other component(s), device(s), system(s), and/or the like. For example, in some embodiments, the development resource and technology operations server 210 is in communication with one or more external apparatus(es), system(s), device(s), and/or the like, to perform one or more of the operations as depicted and described. For purposes of simplifying the description, the method 900 is described as performed by and from the perspective of the development resource and technology operations server 210. In this regard, performance of the operations may invoke one or more of memory 201, processor 202, input/output circuitry 203, communications circuitry 204, and/or development resource and technology operations circuitry 205.

In the embodiment illustrated in FIG. 9, the flowchart illustrates method 900 which begins at block 902. At block 902, the development resource and technology operations server 210 includes means, such as the memory 201, processor 202, input/output circuitry 203, communications circuitry 204, and/or development resource and technology operations circuitry 205, or a combination thereof, to initiate performance of one or more impact value responsive alert actions. In some embodiments, the impact value responsive alert action includes generating and/or transmitting an alert to a user associated with a development resource and technology operations server when the development resource reference unit impact value is below the development resource reference unit impact value threshold.

At block 904, the development resource and technology operations server 210 includes means, such as the memory 201, processor 202, input/output circuitry 203, communications circuitry 204, and/or development resource and technology operations circuitry 205, or a combination thereof, to initiate performance of one or more impact value responsive disablement actions. In some embodiments, the impact value responsive disablement action includes disabling a development resource reference unit such that the development resource reference unit can no longer be accessed by a development resource and technology operations server and/or a user associated with a development resource and technology operations server.

At block 906, the development resource and technology operations server 210 includes means, such as the memory 201, processor 202, input/output circuitry 203, communications circuitry 204, and/or development resource and technology operations circuitry 205, or a combination thereof, to initiate performance of one or more impact value responsive positioning actions. In some embodiments, the impact value responsive positioning action includes changing a positioning of a development resource reference unit in a ranking of a plurality of development resource reference units.

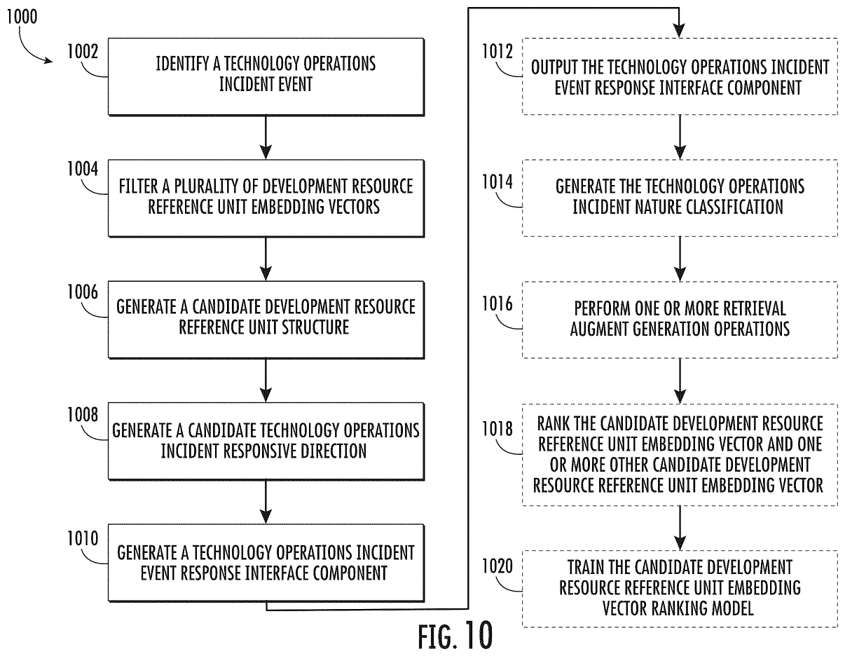

FIG. 10 is a flowchart broadly illustrating a series of operations or process blocks that are executed or performed to output a technology operations incident event response interface component for rendering to a technology operations incident event response interface in accordance with some example embodiments of the present disclosure. In some embodiments, the method 1000 is embodied by computer program code stored on a non-transitory computer-readable storage medium of a computer program product configured for execution to perform the process as depicted and described. In this regard, in some such embodiments, the development resource and technology operations server 210 is specially configured by computer-coded instructions (e.g., computer program instructions) stored thereon, for example in the memory 201 and/or another component depicted and/or described herein and/or otherwise accessible to the development resource and technology operations server 210, for performing the operations as depicted and described. Alternatively, or additionally, in some embodiments, the method 1000 is performed by one or more specially configured computing devices, such as the development resource and technology operations server 210 alone or in communication with one or more other component(s), device(s), system(s), and/or the like. For example, in some embodiments, the development resource and technology operations server 210 is in communication with one or more external apparatus(es), system(s), device(s), and/or the like, to perform one or more of the operations as depicted and described. For purposes of simplifying the description, the method 1000 is described as performed by and from the perspective of the development resource and technology operations server 210. In this regard, performance of the operations may invoke one or more of memory 201, processor 202, input/output circuitry 203, communications circuitry 204, and/or development resource and technology operations circuitry 205.

In the embodiment illustrated in FIG. 10, the flowchart illustrates method 1000 which begins at block 1002. At block 1002, the development resource and technology operations server 210 includes means, such as the memory 201, processor 202, input/output circuitry 203, communications circuitry 204, and/or development resource and technology operations circuitry 205, or a combination thereof, to identify a technology operations incident event. In some embodiments, a data object that describes a problem, error, fault, and/or the like associated with a software application that requires analysis, diagnosis, repair, resolution, and/or the like by a development resource and technology operations system and/or a user associated with a development resource and technology operations system.

At block 1004, the development resource and technology operations server 210 includes means, such as the memory 201, processor 202, input/output circuitry 203, communications circuitry 204, and/or development resource and technology operations circuitry 205, or a combination thereof, to filter a plurality of development resource reference unit embedding vectors. In some embodiments, the plurality of development resource reference unit embedding vectors is filtered to identify a candidate development resource reference unit embedding vector. In some embodiments, the plurality of development resource reference unit embedding vectors is filtered based at least in part on a technology operations incident nature classification associated with the technology operations incident event.

At block 1006, the development resource and technology operations server 210 includes means, such as the memory 201, processor 202, input/output circuitry 203, communications circuitry 204, and/or development resource and technology operations circuitry 205, or a combination thereof, to generate a candidate development resource reference unit structure. In some embodiments, a candidate development resource reference unit structure is generated based at least in part on the candidate development resource reference unit embedding vector. In some embodiments, the candidate development resource reference unit structure is generated by performing one or more retrieval operations based at least in part on the candidate development resource reference unit embedding vector. In some embodiments, the candidate development resource reference unit structure includes a candidate development resource reference unit fragment. In some embodiments, the candidate development resource reference unit structure includes a candidate development resource reference unit link.

At block 1008, the development resource and technology operations server 210 includes means, such as the memory 201, processor 202, input/output circuitry 203, communications circuitry 204, and/or development resource and technology operations circuitry 205, or a combination thereof, to generate a candidate technology operations incident responsive direction. In some embodiments, the candidate technology operations incident responsive direction is generated by processing the candidate development resource reference unit fragment using a technology operations incident responsive direction generation model.

At block 1010, the development resource and technology operations server 210 includes means, such as the memory 201, processor 202, input/output circuitry 203, communications circuitry 204, and/or development resource and technology operations circuitry 205, or a combination thereof, to generate a technology operations incident event response interface component. In some embodiments, the technology operations incident event response interface component includes the candidate development resource reference unit structure and the candidate technology operations incident responsive direction.

At block 1012, the development resource and technology operations server 210 includes means, such as the memory 201, processor 202, input/output circuitry 203, communications circuitry 204, and/or development resource and technology operations circuitry 205, or a combination thereof, to output the technology operations incident event response interface component for rendering to a technology operations incident event response interface.

At optional block 1014, the development resource and technology operations server 210 includes means, such as the memory 201, processor 202, input/output circuitry 203, communications circuitry 204, and/or development resource and technology operations circuitry 205, or a combination thereof, to generate the technology operations incident nature classification. In some embodiments, the technology operations incident nature classification may be generated by processing the technology operations incident event using a technology operations incident event classification model. In some embodiments, the technology operations incident event classification model comprises a support vector machine learning model.

At optional block 1016, the development resource and technology operations server 210 includes means, such as the memory 201, processor 202, input/output circuitry 203, communications circuitry 204, and/or development resource and technology operations circuitry 205, or a combination thereof, to perform one or more retrieval augment generation operations.

At optional block 1018, the development resource and technology operations server 210 includes means, such as the memory 201, processor 202, input/output circuitry 203, communications circuitry 204, and/or development resource and technology operations circuitry 205, or a combination thereof, to rank the candidate development resource reference unit embedding vector and one or more other candidate development resource reference unit embedding vector. In some embodiments, the candidate development resource reference unit embedding vector and the one or more other candidate development resource reference unit embedding vector may be ranked using a candidate development resource reference unit embedding vector ranking model.

At optional block 1020, the development resource and technology operations server 210 includes means, such as the memory 201, processor 202, input/output circuitry 203, communications circuitry 204, and/or development resource and technology operations circuitry 205, or a combination thereof, to train the candidate development resource reference unit embedding vector ranking model. In some embodiments, the candidate development resource reference unit embedding vector ranking model is trained using one or more reinforcement learning operations.

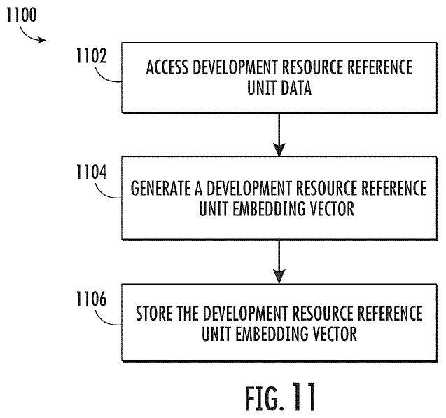

FIG. 11 is a flowchart broadly illustrating a series of operations or process blocks that are executed or performed to output a technology operations incident event response interface component for rendering to a technology operations incident event response interface in accordance with some example embodiments of the present disclosure. In some embodiments, the method 1100 is embodied by computer program code stored on a non-transitory computer-readable storage medium of a computer program product configured for execution to perform the process as depicted and described. In this regard, in some such embodiments, the development resource and technology operations server 210 is specially configured by computer-coded instructions (e.g., computer program instructions) stored thereon, for example in the memory 201 and/or another component depicted and/or described herein and/or otherwise accessible to the development resource and technology operations server 210, for performing the operations as depicted and described. Alternatively, or additionally, in some embodiments, the method 1100 is performed by one or more specially configured computing devices, such as the development resource and technology operations server 210 alone or in communication with one or more other component(s), device(s), system(s), and/or the like. For example, in some embodiments, the development resource and technology operations server 210 is in communication with one or more external apparatus(es), system(s), device(s), and/or the like, to perform one or more of the operations as depicted and described. For purposes of simplifying the description, the method 1100 is described as performed by and from the perspective of the development resource and technology operations server 210. In this regard, performance of the operations may invoke one or more of memory 201, processor 202, input/output circuitry 203, communications circuitry 204, and/or development resource and technology operations circuitry 205.

In the embodiment illustrated in FIG. 11, the flowchart illustrates method 1100 which begins at block 1102. At block 1102, the development resource and technology operations server 210 includes means, such as the memory 201, processor 202, input/output circuitry 203, communications circuitry 204, and/or development resource and technology operations circuitry 205, or a combination thereof, to access development resource reference unit data representative of a development resource reference unit. In some embodiments, the development resource reference unit is stored in a development resource reference unit repository.

At block 1104, the development resource and technology operations server 210 includes means, such as the memory 201, processor 202, input/output circuitry 203, communications circuitry 204, and/or development resource and technology operations circuitry 205, or a combination thereof, to generate a development resource reference unit embedding vector. In some embodiments, the development resource reference unit embedding vector may be generated based at least in part on development resource reference unit data. In some embodiments, the development resource reference unit embedding vector corresponds to the development resource reference unit.

In some embodiments, the development resource reference unit embedding vector is indicative of a development resource reference unit identifier, a development resource reference unit link, a development resource reference unit nature, and development resource reference unit fragment. In some embodiments, generating the development resource reference unit embedding vector comprises processing the development resource reference unit data using a fragment extraction model to generate a development resource reference unit fragment. In some embodiments, generating the development resource reference unit embedding vector comprises processing the development resource reference unit fragment using one or more embedding and indexing operations. In some embodiments, generating the development resource reference unit embedding vector comprises processing the development resource reference unit data using a nature extraction model to generate a development resource reference unit nature.

At block 1106, the development resource and technology operations server 210 includes means, such as the memory 201, processor 202, input/output circuitry 203, communications circuitry 204, and/or development resource and technology operations circuitry 205, or a combination thereof, to store the development resource reference unit embedding vector.

### CONCLUSION

Many modifications and other embodiments of the present disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus for storing a development resource reference unit embedding vector, the apparatus comprising at least one processor, and at least one memory including program code, the at least one memory and the program code configured to, with the at least one processor, cause the apparatus to at least:
access development resource reference unit data from a development resource reference unit repository, wherein the development resource reference unit data is representative of a development resource reference unit;
generate a development resource reference unit embedding vector using the development resource reference unit data, wherein generating the development resource reference unit embedding vector comprises the program code being further configured to, with the at least one processor, cause the apparatus to:
generate a development resource reference unit nature by processing the development resource reference unit data using a nature extraction model;
generate a development resource reference unit fragment by processing the development resource reference unit data using a fragment extraction model; and
process the development resource reference unit fragment by performing an embedding and indexing operation; and
store the development resource reference unit embedding vector in a development resource reference unit embedding vector repository.

2. The apparatus of claim 1, wherein the development resource reference unit embedding vector is stored in the development resource reference unit embedding vector repository using a k-nearest neighbor algorithm.

3. The apparatus of claim 1, wherein performing the embedding and indexing operation comprises the program code being further configured to, with the at least one processor, further cause the apparatus to:
convert the development resource reference unit fragment into a fixed length.

4. The apparatus of claim 1, wherein performing the embedding and indexing operation comprises the program code being further configured to, with the at least one processor, further cause the apparatus to:
annotate the development resource reference unit fragment with the development resource reference unit nature.

5. The apparatus of claim 1, wherein the program code being further configured to, with the at least one processor, further cause the apparatus to:
identify a technology operations incident event;
generate a technology operations incident nature classification by processing the technology operations incident event using a technology operations incident event classification model; and
filter a plurality of development resource reference unit embedding vectors based at least in part on the technology operations incident nature classification associated with the technology operations incident event to identify a candidate development resource reference unit embedding vector.

6. The apparatus of claim 5, wherein filtering the plurality of development resource reference unit embedding vectors comprises the program code being further configured to, with the at least one processor, further cause the apparatus to:
perform a hierarchical semantic search of the development resource reference unit embedding vector repository.

7. The apparatus of claim 5, wherein the program code being further configured to, with the at least one processor, further cause the apparatus to:
process the technology operations incident event using a technology operations incident event preprocessing model, wherein the technology operations incident event is processed using the technology operations incident event preprocessing model prior to filtering the plurality of development resource reference unit embedding vectors.

8. The apparatus of claim 5, wherein the program code being further configured to, with the at least one processor, further cause the apparatus to:
generate a candidate development resource reference unit structure based at least in part on the candidate development resource reference unit embedding vector, wherein the candidate development resource reference unit structure comprises a candidate development resource reference unit fragment and a candidate development resource reference unit link;
generate a candidate technology operations incident responsive direction by processing the candidate development resource reference unit fragment using a technology operations incident responsive direction generation model;
generate a technology operations incident event response interface component comprising the candidate development resource reference unit structure and the candidate technology operations incident responsive direction; and
output the technology operations incident event response interface component for rendering to a technology operations incident event response interface.

9. The apparatus of claim 5, wherein the plurality of development resource reference unit embedding vectors comprises the development resource reference unit embedding vector and wherein the plurality of development resource reference unit embedding vectors are stored in the development resource reference unit embedding vector repository.

10. The apparatus of claim 5, wherein the candidate development resource reference unit embedding vector is associated with a candidate development resource reference unit and a second candidate development resource reference unit embedding vector is associated with a second candidate development resource reference unit and wherein the program code is further configured to, with the at least one processor, cause the apparatus to:
access a development resource reference unit characteristic set associated with the candidate development resource reference unit and a second development resource reference unit characteristic set associated with the second candidate development resource reference unit;
extract a development resource reference unit impact value from the development resource reference unit characteristic set and a second development resource reference unit impact value from the second development resource reference unit characteristic set; and
rank the candidate development resource reference unit embedding vector and the second candidate development resource reference unit embedding vector using a candidate development resource reference unit embedding vector ranking model, the development resource reference unit impact value, and the second development resource reference unit impact value.

11. The apparatus of claim 1, wherein the program code is further configured to, with the at least one processor, cause the apparatus to:
access one or more development resource reference unit training vectors;
train a development resource reference unit assessment model using the one or more development resource reference unit training vectors; and
generate a development resource reference unit impact value by applying resource reference unit data to the development resource reference unit assessment model.

12. A method for storing a development resource reference unit embedding vector, the method comprising:
accessing development resource reference unit data from a development resource reference unit repository, wherein the development resource reference unit data is representative of a development resource reference unit;
generating a development resource reference unit embedding vector using the development resource reference unit data, wherein generating the development resource reference unit embedding vector comprises:
generating a development resource reference unit nature by processing the development resource reference unit data using a nature extraction model;
generating a development resource reference unit fragment by processing the development resource reference unit data using a fragment extraction model; and
processing the development resource reference unit fragment by performing an embedding and indexing operation; and
storing the development resource reference unit embedding vector in a development resource reference unit embedding vector repository.

13. The method of claim 12, wherein the development resource reference unit embedding vector is stored in the development resource reference unit embedding vector repository using a k-nearest neighbor algorithm.

14. The method of claim 12, wherein performing the embedding and indexing operation comprises:
converting the development resource reference unit fragment into a fixed length.

15. The method of claim 12, wherein performing the embedding and indexing operation comprises:
annotating the development resource reference unit fragment with the development resource reference unit nature.

16. The method of claim 12, further comprising:
identifying a technology operations incident event;
generating a technology operations incident nature classification by processing the technology operations incident event using a technology operations incident event classification model; and
filtering a plurality of development resource reference unit embedding vectors based at least in part on the technology operations incident nature classification associated with the technology operations incident event to identify a candidate development resource reference unit embedding vector.

17. The method of claim 16, wherein filtering the plurality of development resource reference unit embedding vectors comprises:
performing a hierarchical semantic search of the development resource reference unit embedding vector repository.

18. The method of claim 16, further comprising:
processing the technology operations incident event using a technology operations incident event preprocessing model, wherein the technology operations incident event is processed using the technology operations incident event preprocessing model prior to filtering the plurality of development resource reference unit embedding vectors.

19. The method of claim 16, further comprising:
generating a candidate development resource reference unit structure based at least in part on the candidate development resource reference unit embedding vector, wherein the candidate development resource reference unit structure comprises a candidate development resource reference unit fragment and a candidate development resource reference unit link;
generating a candidate technology operations incident responsive direction by processing the candidate development resource reference unit fragment using a technology operations incident responsive direction generation model;
generating a technology operations incident event response interface component comprising the candidate development resource reference unit structure and the candidate technology operations incident responsive direction; and
outputting the technology operations incident event response interface component for rendering to a technology operations incident event response interface.

20. A computer program product for storing a development resource reference unit embedding vector, the computer program product comprising at least one non-transitory computer-readable storage medium having computer-readable program code portions stored therein, the computer-readable program code portions comprising an executable portion configured to:
access development resource reference unit data from a development resource reference unit repository, wherein the development resource reference unit data is representative of a development resource reference unit;
generate a development resource reference unit embedding vector using the development resource reference unit data, wherein generating the development resource reference unit embedding vector comprises the executable portion being configured to:
generate a development resource reference unit nature by processing the development resource reference unit data using a nature extraction model;
generate a development resource reference unit fragment by processing the development resource reference unit data using a fragment extraction model; and
process the development resource reference unit fragment by performing an embedding and indexing operation; and
store the development resource reference unit embedding vector in a development resource reference unit embedding vector repository, wherein the development resource reference unit embedding vector is stored in the development resource reference unit embedding vector repository using a k-nearest neighbor algorithm.
